(19) United States
(12) Patent Application Publication
(10) Pub. No.: US 2010/0257539 A1
(43) Pub. Date: Oct. 7, 2010

(54) System, method and apparatus for providing functions to applications on a digital electronic device

(76) Inventors: Krishnakumar Narayanan, Pleasanton, CA (US); John Michael Grubbs, Half Moon Bay, CA (US)

Correspondence Address: David H. Carroll, 9776 Cupola Lane, Eden Prairie, MN, 55347-3622, US

(21) Appl. No.: 12/751,881

(22) Filed: Mar. 31, 2010

Related U.S. Application Data
(60) Provisional application No. 61/211,506, filed on Mar. 31, 2009.

(51) Int. Cl. G06F 9/46

(52) U.S. Cl. 719/311; 719/328

(57) ABSTRACT

To greatly simplify the developer's task, an application function server or application logic controller (“ALC”) server runs on a digital electronic device with a common set of tools and methods to deliver high-value capabilities to applications developed in different application languages and running in various different application environments. The applications and the application function server have a local client-server relationship. The functions themselves are provided by various plug-ins. The interface of a plug-in illustratively is a discrete set of functions, common to the command plug-ins. The ALC Server accepts simplified commands directly from the applications, applies the appropriate policy, and interacts with the plug-ins to perform the requested functions on behalf of the applications. The result is that applications can use various capabilities without dealing with the complex methods, standards, and system interoperability required to make the technologies work, and technology additions and upgrades can be performed independently from the applications that use them.

### CROSS-REFERENCE TO RELATED APPLICATIONS

This application claims the benefit of U.S. Provisional Patent Application Ser. No. 61/211,506 filed Mar. 31, 2009, which hereby is incorporated herein in its entirety by reference thereto.

### BACKGROUND OF THE INVENTION

1. Field of the Invention

This invention relates generally to methods and apparatus, including systems, for controlling digital electronic devices, and more particularly for serving multiple applications in runtime environments on a digital electronic device.

2. Description of the Related Art

FIG. 1 illustrates a communication network, in simplified form for explanation. The communication network includes, for example, a conventional cellular network 10 which may include, for example, GSM, GPRS, EDGE, cdmaOne, cdma2000, WCDMA, and UMTS networks, although other access technologies can also be used. The cellular network 10 is operated by mobile network operators (not shown), which provide voice and/or data services to customers. Three illustrative devices are shown connected to the cellular network 10, namely a cell phone 11, a smartphone 12, and a mobile PC 13 with a cellular network connection device installed. The communications network also includes an IP network and service infrastructure 20, which is interconnected with the cellular network 10 through a gateway (not shown). The IP network 20 provides IP services through both wired and wireless means. Six networked devices are shown connected to the IP network 20, illustratively a server 21, a game console 22, a digital audio/video device such as a set-top-box 24 to which a digital television 23 is connected, a smart digital appliance 25 (such as, for example, a security device, a web camera, or a smart kitchen appliance), a desktop personal computer 26, a mobile personal computer 27 (such as, for example, a laptop, tablet, or netbook computer), and a smartphone 28. Each of the digital electronic devices include suitable software that interfaces with various user applications on the device and functions as a user agent to establish, modify, and terminate communication sessions between any of the networked digital electronic devices, and across different networks.

Services are provided by the network operator and service providers through the network. Services are accessed, delivered, and used through specialized technologies, network and application protocols, and content methods, and operate using various standards. Some functions and applications operate from device-to-device directly and others are originated by servers in the service infrastructure or by servers connected through the internet. The applications on the devices must support the specific standards and technologies used by the various networks, services, content, and other device applications.

Digital electronic devices such as devices 21-28 include application software, which typically is written for the particular type of digital electronic device. Such application software tends to be complex, since it includes not only the user interface and application functions that are specific to the application or service, but also elements that are specific to the end-to-end connection, delivery, and processing of protocols and content as well as the device platform, operating system environment, application environment, and the network and service systems used. Unfortunately, the difficulty of developing device applications that individually deal with the complexity of managing and supporting a variety of device platforms, application environments, technology and standards, networks, and service systems has led to long development and deployment cycles, high cost and risk, and inefficient use and duplication of resources for application developers, device suppliers, and service providers. In addition, this high time and cost has led to single purpose applications and services for new service and application capabilities. The monolithic and vertical nature of these complex applications also limits the available developer community that is capable of creating the applications, increases the cost for specialized training and tools, and reduces flexibility for providers and users to adapt and repurpose the capabilities and functions. They are unable to easily add new applications or user interfaces that support additional uses, adapt for new markets or personalize the use to individual needs or usage styles. This limited application support and availability limits the adoption, use, and economic value of the functions and services.

The technologies and standards used for applications and services continue to evolve and change. As networks, service applications, and content changes, the applications are also changed to include these new requirements, technologies, and standards. Significant time and investment is expended to change each application, to test each application in each device and application environment, and test each application with the various network and service application systems. This adds considerable time, risk, and cost to technology and functional upgrades, and slows transitions to new standards and capabilities.

The number and type of devices has grown dramatically, and each device category, manufacturer, and service may have a wide range of device platforms and operating systems, and multiple application environments, and are required to interoperate across many networks and systems. Since applications are device and service specific, this has limited the availability and use of new functions and capabilities to selected devices. The time and investment required to implement a new capability across an entire, complex device portfolio continues to increase as the range and type of devices increases. Developers, device suppliers, and service providers need a better means to support many device types and models with lower incremental time, cost, and risk to fully utilize investments and to offer services and value to more customers and markets.

The industry has different sets of technology, products, providers and business models that must come together to deliver complete end-to-end services and applications. These may be referred to as industry ecosystems. The primary ecosystems include device platforms, application environments and developer communities, technology and standards, and networks and service infrastructure systems.

The device ecosystem includes components and platforms which vary by category and supplier, operating system environments, and various electrical, software, mechanical and industrial design elements. They include application environments such as native operating system specific application environments such as Windows, MacOS, Linux, Symbian, BREW, Android™, and a variety of specialized real-time-operating systems. There are multiple versions and adaptations of general procedural runtime application environments such as Java, declarative runtime application environments such as Adobe Flash and Air, WebKit Widget Runtime, Yahoo Widgets, and browser based application environments such as Google Gadgets and AJAX enabled mobile and PC browsers. Each of these environments have unique capabilities, advantages and disadvantages, and are suitable for different levels and types of applications. They require specific knowledge and tools and tend to have communities of developers based on the relative number of devices and services that support them and the economic value of developing for those environments.

Many devices include more than one application environment. For example, most smartphones include a native programming environment such as Windows Mobile, Symbian, or Linux, and these may be the preferred environments for core applications that are performance sensitive, security sensitive, or need access to specific platform and OS resources not available in other environments. These are typically very complex applications written in the ‘C’ programming language using the specific platform and operating system resources available, and require special knowledge and skill for the device, programming environment and tools, service systems, specialized technologies, and applicable standards. The device may also include a procedural runtime application environment such as Java. These provide a higher level procedural language and are generally less device specific. However, the functions of the applications are limited to the capabilities supported by the application environment. These environments generally do not provide low-level access to device resources. The applications tend to require less modification to use on other devices with a compatible environment, but they are usually less capable and perform slower than native applications. The device may also include a declarative runtime environment. These environments use more web-like programming and content methods such as scripting and markup languages. Adobe's Flash and the industry standard Asynchronous JavaScript and XML (AJAX) based environments are common examples. In some cases, these application environments may also be installed by the user if they are not included on the device. This means that the very large community of web developers is capable of quickly developing applications for the environment and dynamically delivering them to the device as needed or desired. Unfortunately, the limited programming and application management capabilities of these environments and their lack of access to advanced and specialized functions has limited their use in developing applications for sophisticated services and use that require more specialized capabilities.

The current situation requires developers to address all the complex ecosystem requirements in each application and then to modify the entire application for each combination of device, technology and standards, network, and service. In general, the environments that have the largest developer communities are easier to develop in, and provide more portability across devices and services. However, they also have limited capabilities and are slow to support new technology and standards. This limits the availability of applications for specific needs and markets and decreases the economic value of the capabilities.

### BRIEF SUMMARY OF THE INVENTION

To overcome these and other disadvantages in the art, and to enable the capabilities described, apparatus and methods are described with various capabilities that are useful for enabling and simplifying application development, decreasing development and testing time, and facilitating the availability and portability of applications for runtime environments on many different types of digital electronic devices.

One embodiment of the present invention is a method for providing functions to a plurality of applications running in a plurality of application environments on a digital electronic device, comprising enabling an application function server with at least one function from at least one plug-in through at least one API, the application function server and the plug-in being on the digital electronic device; communicating information pertaining to a function request for the function issued by any one of the applications, between the application issuing the function request and the plug-in and through the application function server; and processing, within the application function server, the information pertaining to the function request to interact with the plug-in and perform the function on behalf of the application issuing the function request. The applications are compliant with an application command protocol comprising commands, notifications, acknowledgements, data relating to the function request, or any combination thereof.

Another embodiment of the present invention is an application function server for providing functions to a plurality of applications running in a plurality of application environments on a digital electronic device, comprising an application manager for tracking registration of the applications and for routing notifications to the applications; a socket server for listening for incoming connections, receiving command messages from the applications, and sending notifications to the applications; a command parser processor for parsing commands from the applications; a command dispatcher for validating commands from the applications; a plug-in manager for loading, tracking and unloading plug-ins; a command manager for processing commands validated by the command dispatcher in accordance with a rules-based policy, and requesting the plug-in manager to execute the processed commands; a policy manager for applying rules and conditions during operations; a database manager for managing data during operations; a security manager for securing data communications and storage during operations; and a core manager module for sequencing initialization and configuration of the application manager, the socket server, the command parser processor, the command dispatcher, the command manager, the plug-in manager, the policy manager, the database manager, and the security manager.

Another embodiment of the present invention is a computer readable storage medium containing computer executable instructions that, when executed by a digital electronic device, cause the digital electronic device to perform a method for providing functions to a plurality of applications running in a plurality of application environments on the digital electronic device. The method comprises enabling an application function server with at least one function from at least one plug-in through at least one API, the application function server and the plug-in being on the digital electronic device; communicating information pertaining to a function request for the function issued by any one of the applications, between the application issuing the function request and the plug-in and through the application function server; and processing, within the application function server, the information pertaining to the function request to interact with the plug-in and perform the function on behalf of the application issuing the function request. The applications are compliant with an application command protocol comprising commands, notifications, acknowledgements, data relating to the function request, or any combination thereof.

Another embodiment of the present invention is a digital electronic device comprising a processor and memory, the processor being operatively configured by instructions in the memory to run a plurality of applications in a plurality of application environments, and to provide functions to the applications in accordance with a method. The method comprises enabling an application function server with at least one function from at least one plug-in through at least one API, the application function server and the plug-in being on the digital electronic device; communicating information pertaining to a function request for the function issued by any one of the applications, between the application issuing the function request and the plug-in and through the application function server; and processing, within the application function server, the information pertaining to the function request to interact with the plug-in and perform the function on behalf of the application issuing the function request. The applications are compliant with an application command protocol comprising commands, notifications, acknowledgements, data relating to the function request, or any combination thereof.

Another embodiment of the present invention is a method and apparatus comprising either a services and application controller or an ALC Server used for a method comprising collecting application use data, and maintaining a database comprising the application use data collected in the collecting step. In a variation of this embodiment, the method may further comprise evaluating the application use data with one of the applications. In another variation of this embodiment, the method may further comprise sharing the application use data through one of the applications.

### BRIEF DESCRIPTION OF THE SEVERAL VIEWS OF THE DRAWINGS

FIG. 1 is a schematic diagram of a communications network and associated digital electronic devices.

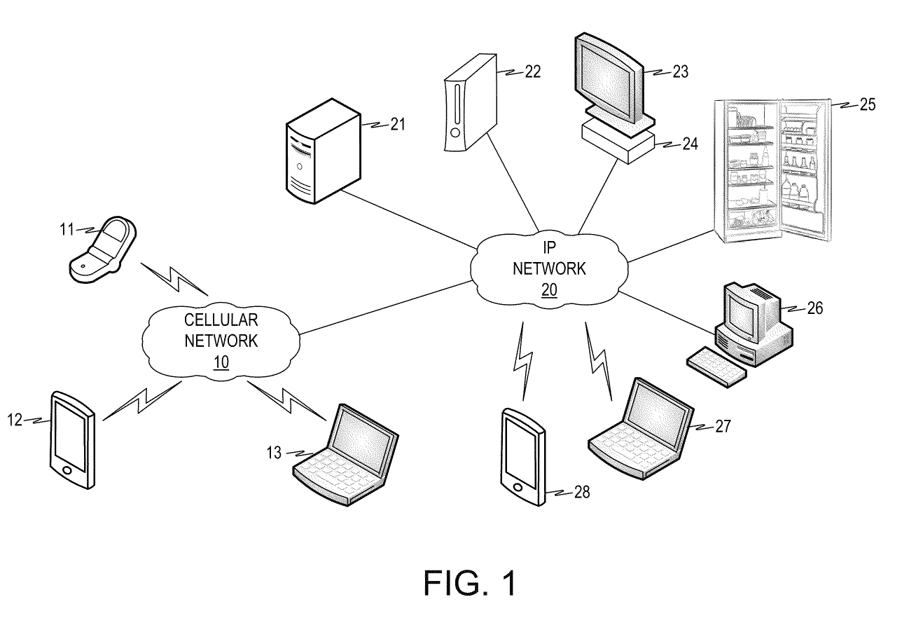

FIG. 2 is a schematic block diagram showing interactions between an ALC Server and an environment.

FIG. 3 is a schematic block diagram showing interactions between an ALC Server and another environment.

FIG. 4 is a schematic diagram of an illustrative implementation in which an ALC server is used for a VoIP Flash application.

FIG. 5 is a schematic diagram of an illustrative call flow for a VoIP application use case where a VoIP Plug-In is used with an ALC Server.

FIG. 6 is a schematic diagram of an illustrative implementation in which an ALC server is used for an IM Flash application.

FIG. 7 is a schematic block diagram of an illustrative implementation of an ALC Server.

FIG. 8 is an example of a command in JSON syntax.

FIG. 9 is a listing of a sample format for an Application Control Document.

FIG. 10 is a listing of a simplified illustrative Application Control Document.

FIG. 11 is a schematic block diagram of an ALC Server with a services and application controller plug-in.

FIG. 12 is a schematic block diagram of an illustrative ASIC implementation of an ALC Server with a services and application controller plug-in and with internal and external plug-ins.

### DETAILED DESCRIPTION OF THE INVENTION, INCLUDING THE BEST MODE

Devices offering rich communications capabilities such as IP Messaging, VoIP, Video Share, and presence may benefit from having various applications running in various application environments such as, for example, the popular Java and Flash environments. Examples include mobile phones, personal computers (“PC's”), mobile internet devices (MID's), and internet protocol television (“IPTV”). While developers seeking to add these rich communications capabilities to their applications may modify their applications by directly coding these rich communications capabilities, this approach is burdensome on the developers because it involves complex and environment-specific coding techniques, as well as current knowledge and mastery of evolving standards such as for SIP/IMS and IP communications. When coding API calls, for example, developers may be faced with numerous API's which function differently and with their own conventions.

To greatly simplify the developer's task, an application function server is established with a common set of tools and methods to deliver high-value capabilities to applications developed in different application languages and running in various different application environments. Interaction between the application function server and the applications uses a command protocol which includes commands, notifications, acknowledgments, and data capable of being delivered in a command line or in a document. The applications and the application function server have a local client-server relationship using any suitable point-to-point, two-way communication technique such as internal Interprocess Communication (“IPC”) calls over a pipe or channel; for example, a TCP/IP socket.

The functions themselves are provided by various plug-ins. The interface of a plug-in illustratively is a discrete set of functions, common to the command plug-ins. Since these interfaces can be considered to be application logic controllers with callable API's that can be communicated with from the applications through the application function server, the application function server may also be thought of as an Application Logic Controller (“ALC”) Server.

The ALC Server accepts simplified commands directly from the applications, applies the appropriate policy, and interacts with the plug-ins to perform the requested functions on behalf of the applications. Any application that can establish a connection (such as a TCP connection), form commands, parse command notifications, and process the appropriate application logic and user interface elements is supported. There are no libraries to link to or include. This means that each application can use these high-value functions regardless of the limitations of the application environment or language. The result is that applications can use various capabilities such as communications (including rich IP communications), entertainment, security, commerce, guidance, data storage and transfer, without dealing with the complex methods, standards, and system interoperability required to make the technologies work, including end-to-end service functions. This abstraction of the applications from the underlying technology also means that technology additions and upgrades can be performed independently from the applications that use them.

The ALC Server can integrate with a great many different types of applications, including, for example, voice over IP, video share, instant messaging, commerce, and so forth. The ALC Server can integrate with a great many different types of plug-ins, which may be command plug-ins or middleware. Examples of suitable client application frameworks, including middleware, are described in United States Patent Application Publication No. US 2009/0222842 published Sep. 3, 2009 (Narayanan et al., “System, Method and Apparatus for Controlling Multiple Applications and Services on a Digital Electronic Device”), which hereby is incorporated herein in its entirety by reference thereto. However, in principle, other implementations of the middle layer including third party middleware may be suitable, and the ALC Server may even be used on a stand-alone basis using proprietary or third party command plug-ins.

The ALC Server runs on a digital electronic device. While the ALC Server does not necessarily require the digital electronic device to be connected to another digital electronic device or to a network, such connections are commonly available and may be used to great advantage by the digital electronic device.

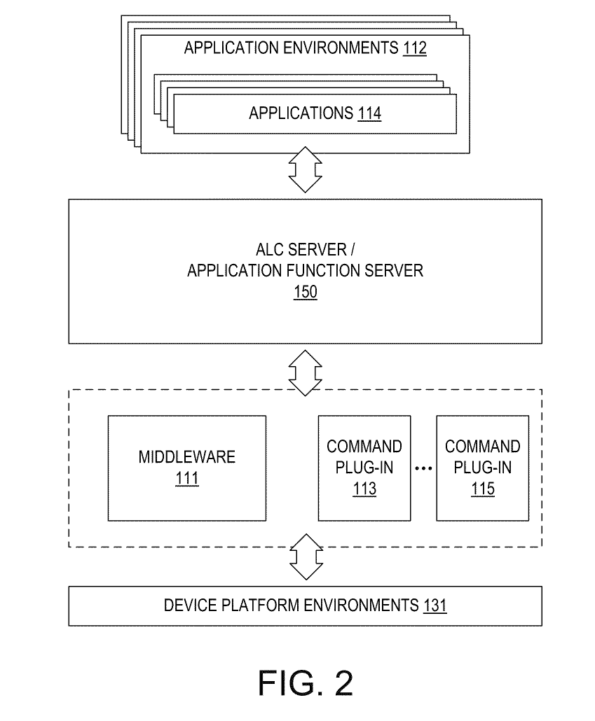

FIG. 2 shows an illustrative system in which an ALC Server 150 handles communication with various applications 114 running in various application environments 112, and processes command requests for available services. Functions may be provided by various command plug-ins, represented by plug-ins 113 and 115. While any desired function may be provided by a command plug-in, varying from access to native functionality to functions that support rich communication services, examples include Contacts, Presence, Messaging (for example, Session Initiation Protocol for Instant Messaging and Presence Leveraging Extensions (“SIMPLE”), Short Message Service (“SMS”), Multimedia Messaging Service (“MMS”)), Calling (for example, Voice over Internet Protocol (“VoIP”) and circuit switched calls), and so forth. Functions may also be provided by middleware, which may also be viewed as a plug-in into the ALC Server 150. The system of FIG. 2 also includes device platform environments 131, and the middleware 111 and command plug-ins 113 and 115 provide device abstraction and an integration layer for support of various communications device platforms.

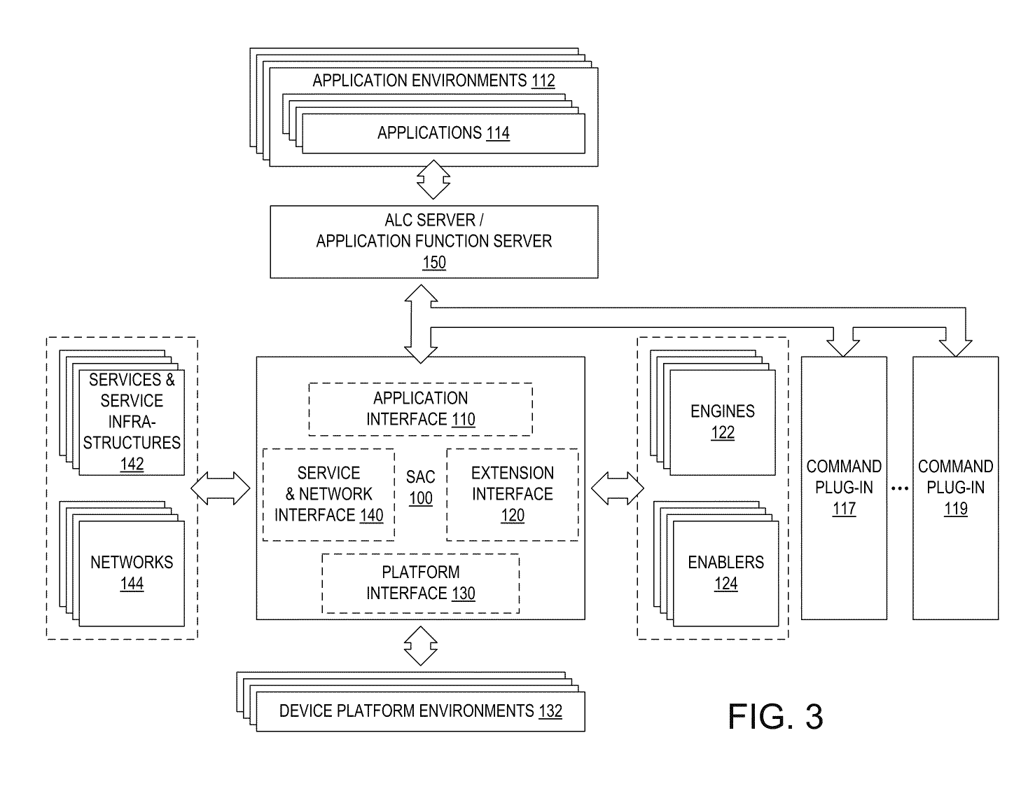

FIG. 3 shows an illustrative client application framework that includes a services and application controller type of middleware, namely a services and application controller (“SAC”) 100, Engines 122 which include a Start Up Engine and User Agent Engine for SIP/IMS Services, and Enablers 124 which include SIP/IMS libraries and enablers. Services may also be provided by various command plug-ins, represented by plug-ins 117 and 119. The SAC 100, which may be a simplified version of the SAC described in United States Patent Application Publication No. US 2009/0222842 published Sep. 3, 2009, which hereby is incorporated herein in its entirety by reference thereto, includes four interfaces which respectively interact with four different environments, namely an application interface 110 that forms a plug-in providing functions to the ALC Server 150, which interacts with applications 114 and application environments 112 and delivers the functions of the client application framework to the application environments 112 and applications 114 in application runtime environments, an extension interface 120 that interacts with engines 122 and enablers 124, a platform interface 130 that interacts with device platform environments 132, and a service and network interface 140 that interacts with services and service infrastructures 142 and with networks 144. The SAC 100 provides a set of core functions and abstracts the environments from each other, which enable interactions between these environments without requiring that the environments be aware of specific aspects of the other environments for the interactions.

The client application frameworks shown in FIG. 2 and in FIG. 3 provide two primary enabling capabilities. First, the framework provides a flexible way for integrating services and platforms, and adding new functions to devices and managing the complex interactions required for access by multiple applications, sessions and supporting various connections. Second, the framework simplifies and serves standard functionality and unique device and service capabilities to applications through the ALC Server 150, running in a variety of application environments. The result is that applications have common access to the essential and specialized functions through the ALC Server 150, which provides a single, abstracted, and simplified method of access independent of the version or technical limits of the application environments. This approach provides an easy way for developers and publishers to add new capabilities to existing applications or develop new categories of innovative applications using familiar tools and methods. Operators and device suppliers can support multiple legacy and next generation functions, perform upgrades, and manage transitions without requiring changes to existing applications. Second, the client application framework handles the complex technologies and interoperability required to make standard and unique technologies work, so operators, device suppliers, and developers can focus on creating more value and a better experience for their products and services. The learning curve and investment required to successfully use additional capabilities is low, as there is no need for detailed knowledge of new technologies, specialized developer training, skills, or new tools. Applications can be created and published by existing developer communities using existing, unmodified application environments, methods and tools. Product and service suppliers are given the flexibility to add proprietary features and “optimizations,” or perform upgrades and system transitions independent of the applications that use them, without requiring upgrades to (or replacement of) the application portfolio. Easier, faster development cycles and deployments offer the opportunity for greater creativity, innovation, and competitive differentiation. Existing developer communities can add valuable service to a broad range of applications and uses—not just one or two. This technological advance accelerates time-to-revenue, lowers risk and increases return on the operator's IMS investment. New ideas can be developed into concepts and validated in weeks rather than years. And when major new systems and technologies are deployed, all parties maintain the flexibility to manage transitions independent of the application portfolio.

ALC Server

The ALC Server 150 shown in the implementations of FIG. 2 and FIG. 3 enables communication with applications in any of the environments, including native application environments, procedural runtime environments, and declarative runtime environments. The ALC Server 150 performs services locally rather than remotely over an external network, and uses local resources to perform these services. The local resources may be provided internal to the ALC Server 150 (not shown), or as plug-ins to the ALC Server 150. Communication between the applications or the environments and the ALC Server 150 may, for example, be done over sockets or ports using Application Control Documents (“ACD”) or command level methods. While it is simple and effective to use the ALC Server 150 to provide functions to the applications, applications and environments may if desired make calls directly to suitably designed API's in the SAC 100 (FIG. 3). Illustratively, native applications and application environments may by design be capable of making calls to API's in the Application Interface 110 directly, so that connections between the native applications and application environments and ALC's in the SAC 100 may be supported with or without a connection between the ALC Server 150 and the native applications and application environment. However, in view of the advantages of using the ALC Server 150 to provide services to the procedural runtime environment and the declarative runtime environment and the applications running therein, connections between these applications and environments and the ALC's in the SAC 100 is rarely desirable, since it is advantageous to avoid any need for modification of these environments. Where connections between an environment and both the ALC's in the SAC 100 and the ALC Server 150 are present, the application developer may use ADC or command line methods or API calls to the ALC's, although for some environments the use of API calls may require modification of the environment.

The ALC Server 150 enables additional functionality to be provided for runtime environments and applications without need for modification of the runtime environments. The types of applications and environments benefited include, for example, browsers enabled with AJAX such as the Opera browser or with proprietary plug-ins like Microsoft Silverlight and Adobe Flash and Air, widget engines from Nokia and Apple, proprietary environments like Adobe's Flash Lite, and AJAX based widget environments like Yahoo Widgets and Webkit Run-Time.

The ALC Server 150 includes a suitable server interface. While many different interfaces may be used, one suitable protocol is to exchange structured information using Extensible Markup Language (“XML”) as the message format. In accordance with this interface protocol, the payload is the ACD in the XML message format. The XML document is created using any suitable documentation creation methodology, and exchanged through a socket or port. While other message formats may also be used, XML is particularly suitable since many environments employ data structures based on XML.

The ALC Server 150 may be written or enabled through plug-ins for a great many different types of applications, including, for example, voice over IP, video share, instant message, commerce, and so forth. The ALC Server 150 includes a parsing function to create and update the ACD's, and a series of protocol translators to translate between commands that the individual applications understand, and commands that the plug-ins understand.

Although shown in FIG. 3 as cooperating with various elements of the SAC 100, the ALC Server 150 may be used on a stand-alone basis to access functionality available from or through third party middleware, with or without the presence of the SAC 100. Illustratively, the ALC Server may incorporate ALC's, or may integrate with ALC's in the third party middleware, or may do both. Illustratively, the ALC Server 150 may communicate with such third party middleware through a pipe. An example of suitable third party IMS middleware is the Symbian IMS, which may be used to build applications such as VoIP or Instant Messaging as disclosed in a white paper by Symsource Ltd. entitled An Introduction to IMS, Version 1.1, which bears an alleged creation date of January 2008; and in a white paper by Symsource Ltd. entitled Symbian OS IMS APIs, which bears an alleged creation date of April 2008. The ALC Server 150 may be designed to be used with this Symbian middleware and build similar VoIP or IM applications.

### SAC Plug-in Implementation Example

### Flash Runtime Adapter for a VoIP Flash Application

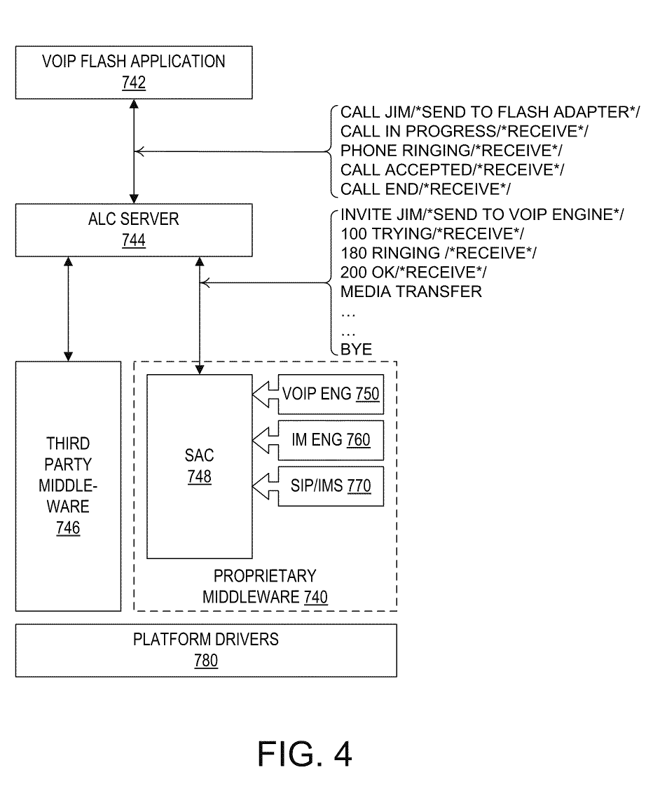

FIG. 4 is an illustrative embodiment of an ALC Server 744 that is suitable for a VoIP Flash application using a SAC plug-in 500. A Flash VoIP application 742 may run in a browser widget application environment. The Adobe Flash Player provides the User Interface (“UI”), and a suitable scripting language (ActionScript) is available. The ALC Server 744 includes an XML parser and a suitable protocol translator. The XML parser is illustrative, since other document formats may be used instead. The Flash application 742 generates an XML document, which the XML parser knows how to interpret. The ALC Server 744 passes the interpreted document to the SAC 748.

In the specific example, the request “Call Jim” is provided by the application 742 to the ALC Server 744, which translates it to “Invite Jim” and sends it to a VoIP Engine 750. SIP commands 100, 180 and 200 are provided to the ALC Server 744, which translates them to Call in Progress, Phone Ringing, and Call Accepted for the Flash application 742. When call is completed, a SIP command BYE is sent to the ALC Server 744, which translates it to “Call End” for the Flash application 742.

### Command Plug-in Implementation Example

### VoIP Plug-in

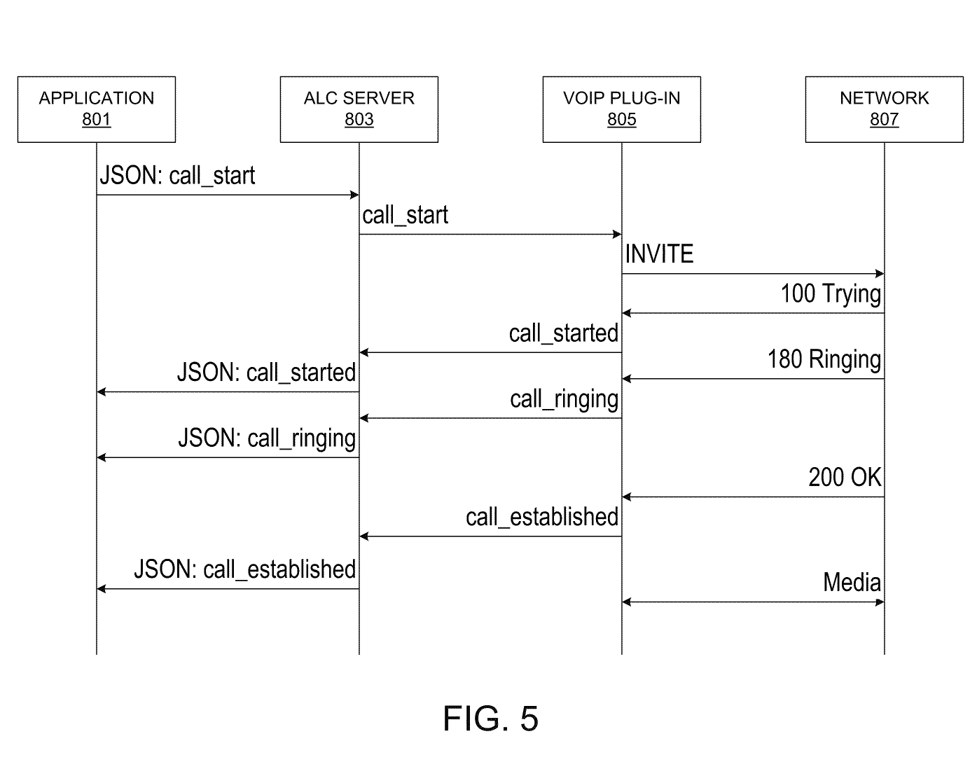

An example of a simple call flow for a VoIP application use case where a VoIP Plug-In is used with an ALC Server 803 is shown in FIG. 5. Using JSON syntax, for example, an application 801 requests the ALC Server 803 to start a call. The ALC Server 803 issues a call start to a VoIP Plug-in 805, which sends an invite to a network 807 and sends a message to the ALC Server 803 that a call has been started. The ALC Server 803 then sends a message to the application 801 that a call has been started. The network 807 replies with a ringing notification to the VoIP Plug-in 805, which in turn sends a message to the ALC Server 803 that the call is ringing, which in turn sends a message to the application 801 that the call is ringing. In due course, the network 807 sends a message to inform the VoIP Plug-in 805 that the call is established, which in turn sends a message to the ALC Server 803 that the call is established, which in turn sends a message to the Application 801 that the call is established. A desired media exchange may then occur between the VoIP Plug-in 805 and the Network 807. Note that the Application 801 does not need to know anything about SIP/IMS, and the ALC Server 803 does not need to know anything about SIP/IMS.

### Command Plug-in Implementation Example

### Commerce

An embodiment of an ALC Server that is suitable for a commerce application includes a Commerce Plug-In. This plug-in includes a digital identity engine which manages the user's application and service identities and credentials; a digital wallet engine which manages the user's information such as banking accounts, credit cards, payment credits, financial and points information, loyalty and membership information; a merchandising manager engine which handles merchandising items such as advertisements, promotions such as coupons and special offers, and recommendations; a situation engine which provides situation awareness information such as location, availability, local connection and service availability; a context engine which provides preference, history, and use profiling functions and information for authorized applications, services, and engines; a redemption engine which manages, delivers, tracks, and reports redemptions of items such as coupons, rebates, and membership points at point of sale; and a payment engine which handles payments at points-of-sale. Additional modules may include an enabler which supports the beaming of barcode data to barcode readers, and a Near-Field-Communication (“NFC”) enabler which supports NFC transmission to NFC transceivers. The MoBeam® technology is available from Ecrio Inc. of Cupertino, Calif., USA, and is described along with a variety of personal digital electronic devices in a number of patents and patent applications, including U.S. Pat. No. 6,685,093 issued Feb. 3, 2004 to Challa et al.; U.S. Pat. No. 6,877,665 issued Apr. 12, 2005 to Challa et al.; U.S. Pat. No. 7,028,906 issued Apr. 18, 2006 to Challa et al.; U.S. Pat. No. 7,395,961 issued Jul. 8, 2008 to Challa et al.; and US Patent Application Publication No. US 2008/0035734, published Feb. 14, 2008 in the name of Challa et al., all of which hereby are incorporated herein in their entirety by reference thereto.

### SAC Plug-in Implementation Example

### Flash Runtime Adapter for an IM Flash Application

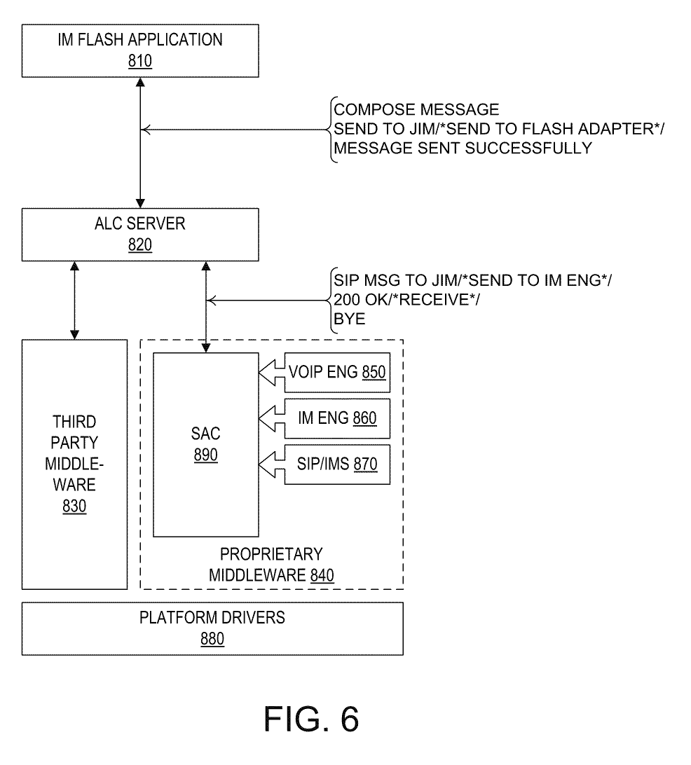

FIG. 6 is an illustrative embodiment of an ALC Server 820 that is suitable for an IM Flash application. The ALC Server 820 functions in a manner similar to the ALC Server 744, except that it performs IM related services. Specifically, the Flash application 810 composes an IM message and provides the command “Send to Jim” to the ALC Server 820, which converts it to “SIP message to Jim” which is then sent to the IM engine 860. SIP command 200 is provided to the ALC Server 820, which translates it to “Message Sent Successfully” for the Flash application 810.

### ALC Server Implementation Example

### Core Functions

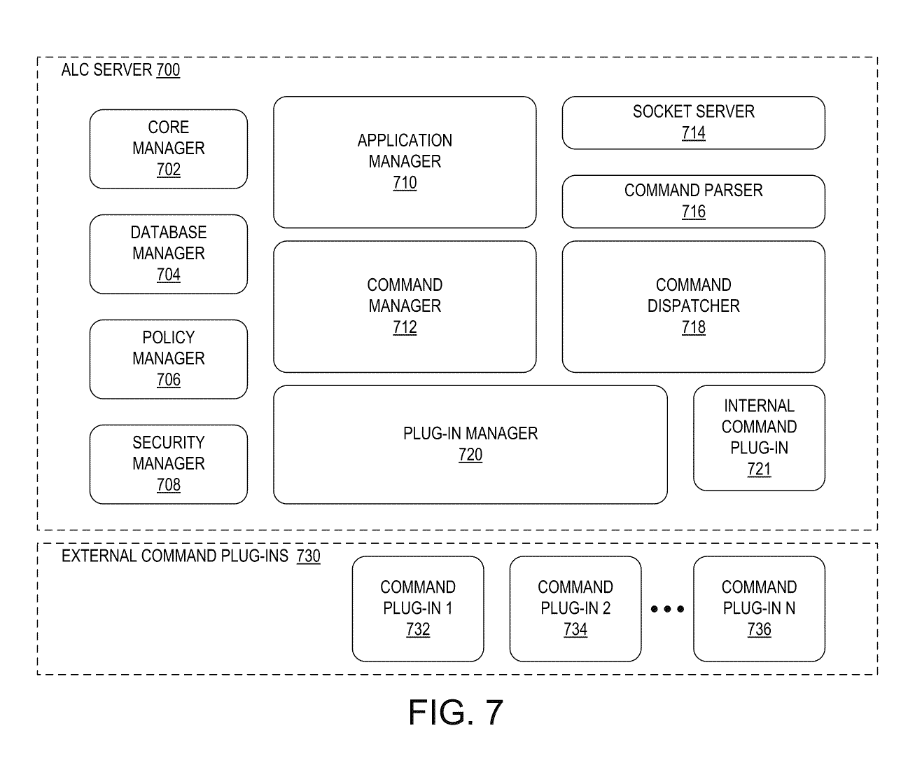

FIG. 7 is a schematic block diagram of an illustrative implementation of an ALC Server 700. The ALC Server 700 is a service executable that interfaces applications with functions both on the device and over a network such as IMS. The ALC Server 700 is a host for services that can process a variety of requests for functions from applications. The process that executes the ALC Server 700 also includes a set of Command Plug-ins, which are special libraries that wrap one or more functions which an application might be interested in utilizing. In general, there are two categories of Command Plug-ins that may be implemented. One type includes those that abstract a native service already on most devices, such as an SMS service. The other type includes libraries that invoke functions such as messaging, VoIP or Video Share. Command Plug-ins may be external to the ALC Server 700; see, for example, Command Plug-ins 732, 734 and 736; or they may be internal; see, for example, Internal Command Plug-in 721. Both types may be used together.

The Application Function Server

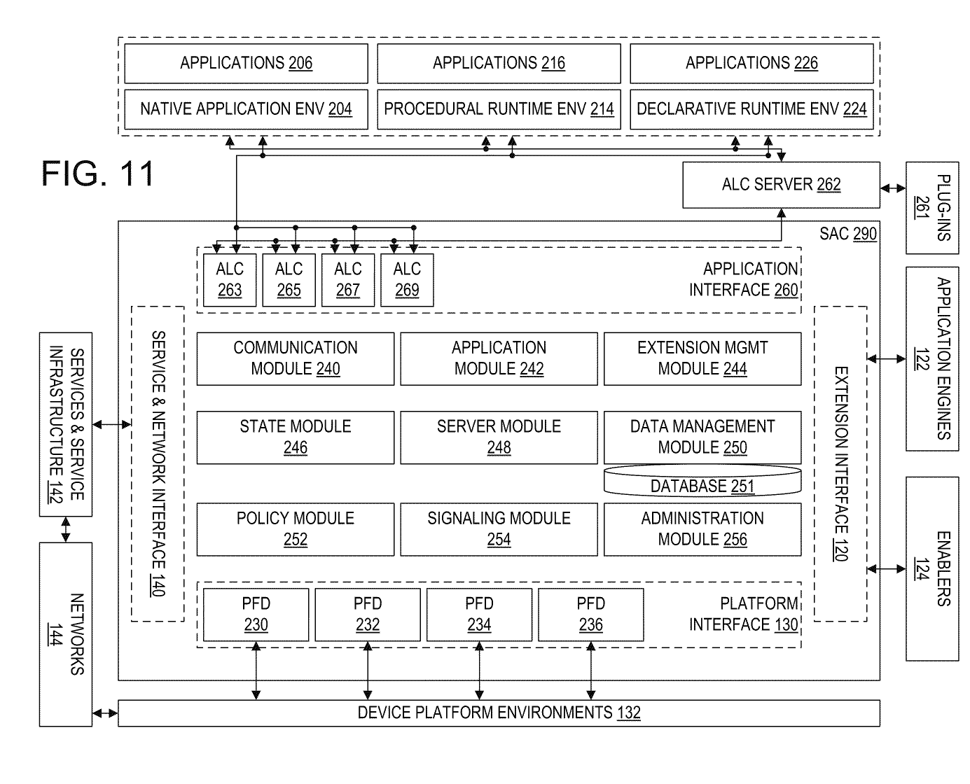

When the ALC Server 700 service starts, it reads a configuration file that includes a list of command plug-ins to use, capabilities, rules and policies of the ALC Server 700, and parameters used during the operation of the ALC Server 700 such as a TCP port used to listen for incoming commands from applications. The configuration file can be an XML based file. The ALC Server 700 initializes the internal modules first. This prepares the internal environment to start processing registrations, command requests and responses, and build up all structures needed to track applications and command plug-ins. Command plug-ins are specified in the configuration file of the ALC Server 700, including the complete path for their location. The ALC Server 700 utilizes a platform driver module (for example, Platform Drivers (“PFD's”) 230, 232, 234 and 236 as shown in FIG. 11) to request the operating system to load the plug-ins in a platform specific manner. Once loaded, the ALC Server 700 obtains the function pointers to the published API exposed by the command plug-ins. The ALC Server 700 invokes each command plug-in initializing API, allowing the plug-in to perform its own basic initialization. If this function returns failure, the plug-in is unloaded and ignored. After this step, the ALC Server 700 reads the capabilities, rules and policy information from the policy file, processes them, and sets up the internal process for operation of the ALC Server 700 per the defined policy, including access to and use of the functions in the plug-ins. For example, a policy may determine the appropriate method of performing a function request among several available options based on conditions and priority. The ALC Server 700 then starts Socket Server 714 that allows the ALC Server 700 to listen for commands from applications, for example, using one or more sockets.

The ALC Server 700 performs the following for each command: parse the application header and validate the application; parse the command on behalf of the command plug-in; confirm that the capability exists to handle the command; confirm that policy allows the command to be handled; and interact with the plug-in to perform the function requested by the command on behalf of the application issuing the command.

Command plug-ins may need to post responses to applications. Responses from the command plug-ins are provided to the ALC Server 700 which will in turn form the application response and provide it to the correct application. The ALC Server 700 gracefully exits when the device powers down or by any other authorized scheme. During this exit process, the ALC Server 700 closes all the socket connections used to communicate with the applications, and unloads all command plug-ins.

Core Manager 702

The Core Manager 702 is the first entity initialized, and sequences the initialization and configuration of all other modules.

Application Manager 710

The Application Manager 710 tracks registered applications and routes notifications to the correct application.

Socket Server 714

The Socket Server 714 is responsible for listening for incoming TCP/IP connections and then for receiving command messages and sending notifications from/to applications. When receiving commands, the Socket Server 714 ensures that the command string is complete, after finding a byte terminator in the stream. The Socket Server 714 utilizes the platform driver's socket module for all socket-based communications. Some runtime environments do not support TCP/IP connections, but support HTTP/HTTPS connections; for example, a BONDI based widget runtime environment that supports HTTP. In these environments, the ALC Server 700 includes a HTTP/HTTPS server. When HTTP/HTTPS servers are used, the application (or a widget in case of a widget runtime environment such as WebKit or BONDI) sends commands wrapped in an HTTP request to the ALC Server 700 (for example using the AJAX XMLHttpRequest( )). When the request needs to be securely transmitted, the application uses HTTPS, an industry standard SSL encryption algorithm, to encrypt the command request. As an alternate implementation, an HTTP/HTTPS proxy server can exist that accepts HTTP/HTTPS requests from applications, parses the requests, extracts the commands and transmits them to the ALC Server 700 using a TCP/IP socket. The exact mechanism of transmitting commands from applications to the ALC Server 700 can vary based on the implementation such as sockets, pipes, shared memory, files, streams and any of the inter-process communication paradigms.

Command Parser Processor 716

The Command Processor 716 is focused on the mechanics of parsing and forming a string command message from an application into a C structure that can be used by the other modules of the ALC Server 700, and vice versa.

Command Dispatcher 718

The Command Dispatcher 718 validates commands to ensure they are syntactically correct and then it will send the command to either a Command Manager 712 for further processing or to the Application Manager 710 if the command is a reserved command that can directly be processed by the ALC Server 700 itself, such as the register command.

Command Manager 712

The Command Manager 712 processes each command through a rules-based policy engine before asking a Plug-in Manager 720 to execute the command.

Plug-in Manager 720

The Plug-in Manager 720 is responsible for loading, tracking, and unloading command plug-ins.

Command Plug-ins 721, 732, 734, 736

Command Plug-ins 721, 732, 734 and 736 provide services that implement functionality around commands. The command plug-ins 721, 732, 734 and 736 use well known mechanisms for dynamic link libraries. Each of the command plug-ins 721, 732, 734 and 736 may comprise three parts: a platform specific plug-in shell; a command plug-in interface; and a command implementation. The plug-in shell wraps the plug-in implementation in a platform specific mechanism. For example, in Windows and Windows Mobile, generic DLL (Dynamically Linked Libraries) entry points are used for loading. The command plug-in Interface is a set of standard functions which are directly callable by name when the plug-in is loaded. The interface is a discrete set of functions, common to the command plug-ins. The ALC Server 700 interfaces with each interface. A command plug-in is unloaded when the ALC Server 700 itself shuts down. Some common implementations include but are not limited to the following.

Initialize Command Plug-in. The ALC Server 700 calls an API after loading the command plug-in. The command plug-in initializes its data structures and variables during an API invocation.

De-Initialize Command Plug-in. When the ALC Server 700 calls this API, the command plug-in releases system resources such as memory, and cleans up its data structures.

Get Information of Command Plug-in. The ALC Server 700 calls this API to obtain identity information about the command plug-in. For example, the information may include name, developer, and version of the command plug-in.

Get List of Commands. The ALC Server 700 calls this API to obtain list of commands the command plug-in exposes to applications. Usually, the list contains a structure that holds name of the command, number of parameters.

Arm Command Plug-in. The ALC Server 700 calls this API to inform the command plug-in to initiate the plug-in. This is an asynchronous function. The command plug-in notifies the ALC Server 700 when it is armed.

Disarm Command Plug-in. The ALC Server 700 calls this API to let command plug-in know that the ALC Server 700 wants to stop using the command plug-in. This is an asynchronous function. The command plug-in is expected to gracefully close any sessions or any other command operations in progress, and notifies the ALC Server 700 when it is disarmed.

Execute Command. The ALC Server 700 calls this API to request command plug-in to execute a specific command from the list of commands it had obtained previously.

Command Protocol and Syntax

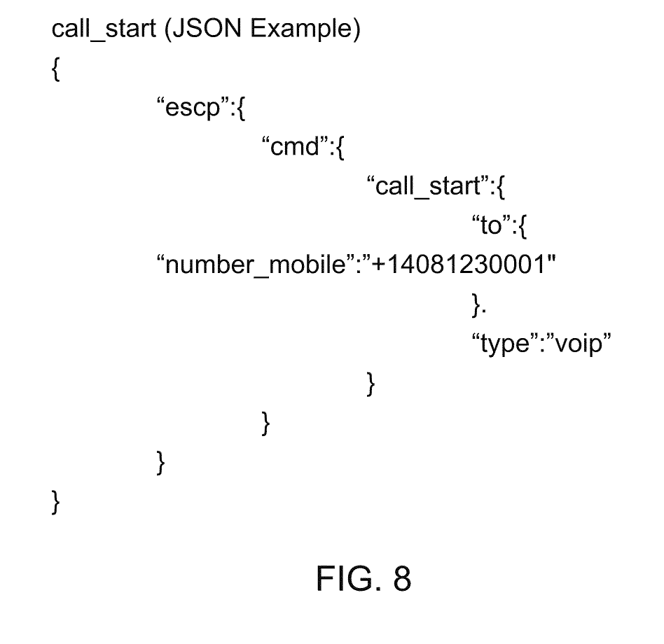

Communication between applications and the ALC Server 700 is done through a suitable command, response, and notification protocol to enable communication between one or more applications and the ALC Server 700. Commands are sent from applications to the ALC Server 700, and command notifications are then sent back to applications asynchronously. The underlying format for the command protocol may utilize, for example, JavaScript Object Notation (“JSON”). JSON is defined as “a lightweight data-interchange format”. The command protocol may utilize only the basic structures provided by JSON. JSON syntax is easy to type and is human readable, very much similar to XML. An application utilizes JSON forming and parsing libraries which can convert the ESCP data into objects. This scheme allows all elements of the command protocol to be quickly validated and utilized. More information about JSON is available at http://www.json.org/. An example of JSON syntax is shown in FIG. 8, for a simple call flow for an application using VoIP as shown in FIG. 5.

Examples of suitable commands are as follows. Illustrative Contact List commands include contacts_get, contact_get, contact_add, contact_modify, contact_remove, contact_subscribe, and contact_unsubscribe; and notifications such as contact_add_success and contact_added. Illustrative File Share commands include send_start, send_end, send_accept, send_reject, send_subscribe_incoming, and send_unsubscribe_incoming; and notifications such as send_started and send_established. Illustrative Video Share commands include stream_start, stream_end, stream_accept, stream_reject, stream_subscribe_incoming, and stream_unsubscribe_incoming; and notifications such as stream_started and stream_established. Illustrative Presence commands include presence_set, presence_subscribe, presence_unsubscribe, presence_subscribe_auth_request, presence_unsubscribe_auth_request, presence_accept_auth_request, and presence_reject_auth_request; and notifications such as presence_data and presence_set_success. Illustrative IM and SMS/MMS commands include message_send, message_session_start, message_session_send, message_session_end, message_session_accept, message_session_reject, message_subscribe, message_unsubscribe, message_subscribe_incoming_session, and message_unsubscribe_incoming_session; and notifications such as message_incoming and message_send_success. Illustrative Voice Calling commands include call_start, call_reject, call_accept, call_hold, call_mute, and call_speakerphone_on; and notifications such as call_started, call_incoming, call_ringing, and call_established. An illustrative Location command is location_get; and notifications such as location data and location failure.

Policy Manager 706

The Policy Manager 706 applies rules and conditions during the operation of the ALC Server 700. The rules and conditions are specified in a policy configuration file. This file can be either static or dynamic. When a dynamic policy configuration file is used, this file may be updated over-the-air by the service provider. One of the policies define how commands used by the ALC Server 700 are applied to command plug-ins. The policy file may be an XML formatted file that is easily parsed to determine the rules and conditions. An example of a sample policy configuration file is given below:

<POLICY>

<COMMAND name=“message_send”
default=“1”></COMMAND>
<COMMAND name=“call_start”
default=“2”></COMMAND>
<COMMAND name=“presence_subscribe”
default=“3”></COMMAND>
<COMMAND name=“stream_subscribe_incoming”
default=“4”></COMMAND>

</POLICY>

There are four entries in this case, meaning that there are four commands mapped to various plug-ins. In this policy, the “message_send” command is mapped to the plug-in whose ID is 1.

Conditions allow the policy to become more flexible with the ability to make decisions based on both static and real-time circumstances. Each command defined in the policy section can have one or more conditions associated with it, and conditions themselves can be nested. The following example shows a condition for a generic command.

<COMMAND name=“command_name” default=“1”>

<CONDITION type=“arg” arg=“name” op=“=”
value=“John” next=“nil” default=“2”/>

</COMMAND>

In the case of the example, if the condition is true, plug-in 2 would be used, else plug-in 1 would be used. Conditions can have many different attributes, and all attributes are not always required in the condition because they either have default values or are dependent on other attributes. A condition is a set of parameters that can be evaluated to be either true or false. If false, then the default plug-in specified at the higher nesting level will be used, ultimately ending with the default specified by the command entry itself. Otherwise, if the condition is true, the default plug-in specified by the condition would be used or the next condition, if any, would be examined.

Database Manager 704

The Database Manager 704 is responsible for management of data within the ALC Server 700. The database methodology of the database manager may be varied based on the implementation requirements. For example, the database can be in-memory on devices that do not have an external storage device, such as set-top-boxes and mobile phones. The database can be a persistent database on a storage device embedded or connected to the device, such as a flash memory card or disc drive. Various database management methods such as SQL, Access, Oracle, and IBM database systems may be employed. The data manager module abstracts this mechanism through the various Applicator modules. To store or share data, any module within the ALC Server 700 defines a structure using a data structure document.

The Database Manager 704 operates on a database that stores data that is relevant for the ALC Server 700, the command plug-ins, and for other purposes such as use tracking. For example, the database may contain the application identifiers and number of applications registered, the commands and number of uses an application has performed, the periods of time the applications are registered, the location of the device when the applications are registered and functions used, most or least often used command type from an application, last command type used, number of notifications an application received, most or least often notifications sent to an application, and any other application related analytics that the ALC Server 700 is aware of and can store in the database. Likewise, the database may contain the number of command plug-ins loaded in the system, most or least often invoked command plug-in, last command plug-in invoked, and any other command plug-in related analytics that the ALC Server 700 is aware of and can store in the database.

Security Manager 708

The Security Manager 708 is responsible for all aspects of application access to the ALC Server 700, including access to functions and notifications, securing data stored, communicated between application and the ALC Server 700, and communicated between modules of the ALC Server 700 and the command plug-ins. The data within the ALC Server 700, including policy configuration files, may be encrypted and stored securely. Any of the industry standard strong encryptions such as 3DES (Triple Data Encryption Standard) can be used. The communication between application and the ALC Server 700 may also be secured using any of the industry methods such as TLS (Transport Level Security) or SSL (Secure Sockets Layer). This also prevents spoofing of data that are either stored in the ALC Server 700 or communicated over the socket between application and the ALC Server 700. The communication between modules of the ALC Server 700 and the command plug-ins may use C-based function invocation, which is secured.

Application Control Documents and Command Line Interface Methods

The ALC Server 150 may parse and exchange multiple request/response items in a single package over environment ports or sockets between the ALC Server and the applications in the various environments. While various packaging methods may be used, one suitable method is the exchange of Application Control Documents (“ACD's”). Another is by using command line interface methods.

ACD's may be used by the applications in the application environments to perform a variety of different functions, including (a) to send and register application identity and descriptors to the ALC Server; (b) to send required authentication, security and access information to a SAC; (c) to discover available functions, data, state information, signaling information, etc.; (d) to define and register data, state information, signaling information, etc.; (e) to request the ALC Server to perform functions; (f) to receive progress/status notices, acknowledgments, results from the ALC Server; (g) to receive signaling events and information from the ALC Server; and (h) to send data, state information, signaling events and information, etc. to the ALC Server.

These functions may be used to improve a user's experience. Consider the example of playing a game called “Joe's Game Application,” which illustratively is a Java application. The ability to send and register application identity and descriptors to an ALC Server allows Joe's Game Application to identify itself to and register with the ALC Server. The application thereafter is detectable in response to the question of what applications are installed and available. The ability to send required authentication, security and access information to an ALC Server allows Joe's Game Application to give the ALC Server its credentials, thereby allowing the ALC Server to establish which functions and other resources the game may be granted access to. The ability to discover available functions, data, state information, signaling information, and so forth allows for Joe's Game Application to inquire and learn whether game buddies are online, their locations, user preferences, and game scores. The ability to request an ALC Server to perform certain functions allows the user of Joe's Game Application to request the ALC Server to perform certain functions such as PTT or Voice call while playing the game. The ability to request data, state information, and so forth enables the user of Joe's Game Application who may have been away to learn what has taken place since the prior session. The ability to receive progress/status notices, acknowledgments, results from the ALC Server for requests, and so forth allows the user to be notified of events during gameplay, and the application to receive requested information from ACD's returned with data. The ability to receive signaling events and information from an ALC Server allows the user to suspend a game and the game timer when certain events occur, such as an incoming call, a change in location, or action requested by another application.

These functions may also be used to achieve new results through collaboration. The ability of applications to send information to an ALC Server, other middleware, and command plug-ins enables collaboration. Consider location. A native application may monitor GPS signals and detect when location has changed, and update the database. Another application may be notified of the location change, acquire the corresponding street address, and place the street address in the database (which now has GPS coordinates and street address). Another application may be notified that the coordinate and address information exists, acquire a local map using a map URL, and add the map to the database. Any other application may then access the map with the location identified and the street address indicated, even though the information may have been separately placed in the database by three different applications.

ACD's may be used by an ALC Server to perform a variety of different functions, including (a) to identify requesting applications; (b) to confirm and administer authentication, security and access privileges; (c) to “publish” authorized capabilities and availability information to authorized applications in the application environments for functions, data, state, and so forth, so that other applications can discover the new application and gain access to it; (d) to receive and process requests from applications to define and register data and state information; (e) to receive, process, and respond to authorized requests for functions, data, state, and so forth (regardless of the applications or application environments); and (f) to send, receive, and process signaling requests and notifications.

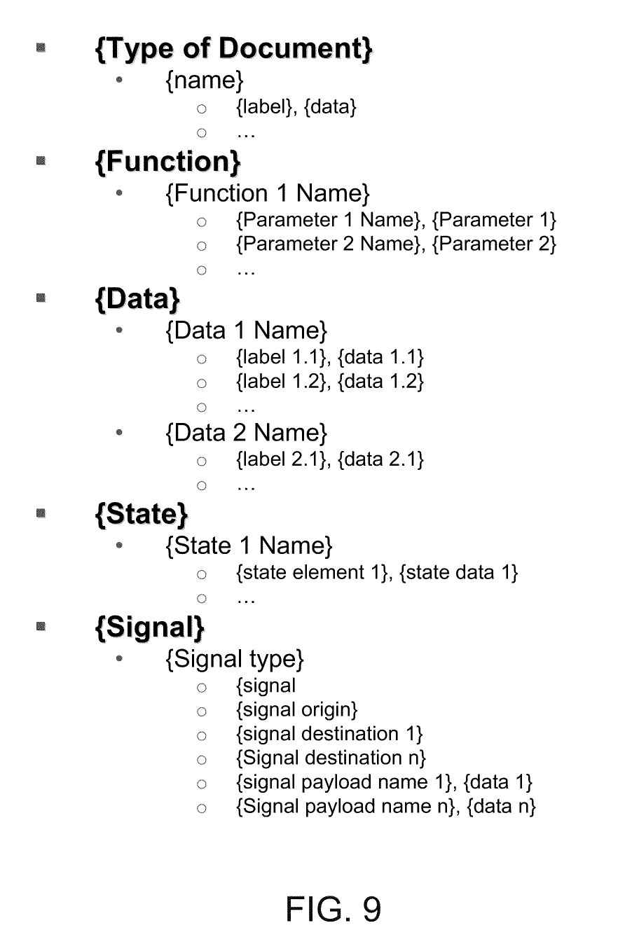

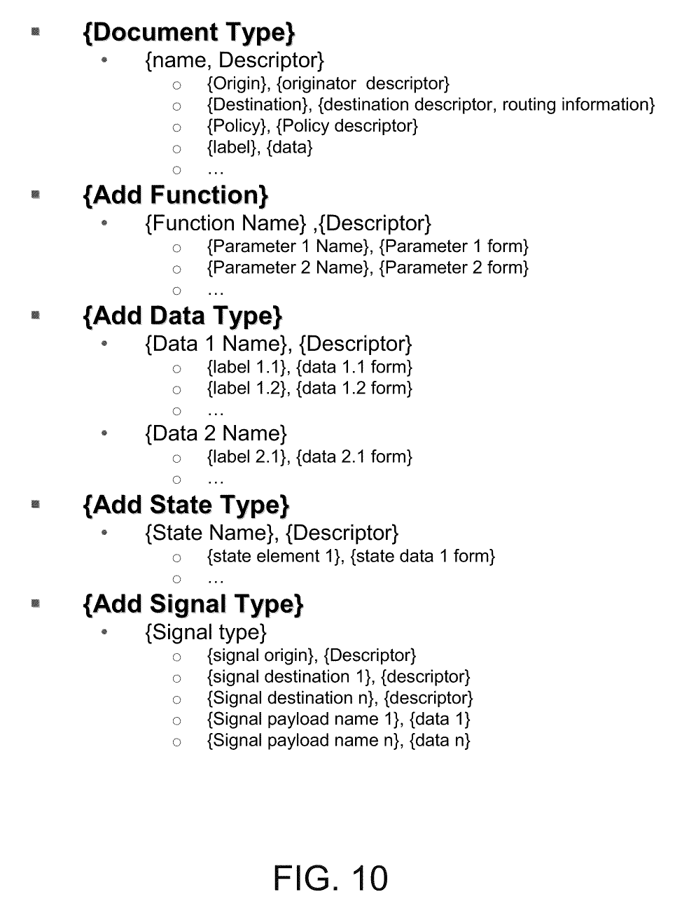

Command line interface methods may also be used to provide multiple request/response items that may be packaged in a single document. FIG. 9 shows a sample format for such a document, and FIG. 10 shows a simplified example of such a document. Suitable documents include various elements such as Function Calls, Data Sharing, State Sharing, and Signaling. Function Calls include Function Call to the ALC Server, function request mapping and routing (Application to ALC Server), and parameter structure and payload mapping and routing for function calls. Data Sharing includes data type, name, to database mapping and query, data structure and payload mapping and storage (Application to ALC Server), and data structure and payload mapping and retrieval (ALC Server to Application). State Sharing includes state type name to database mapping and query, state structure and payload mapping and delivery (ALC Server to Application), and state structure and payload mapping and storage (Application to ALC Server). Signaling includes signal mapping and routing types (Event, Run app, . . . ) and payload (message, parameters, . . . ), signaling message mapping, routing, and delivery (ALC Server to Application), and signaling message mapping, routing, and storage (Application to ALC Server).

### SAC Plug-in Implementation Example

FIG. 11 is a schematic block diagram of the core functions and interfaces of an illustrative and client application framework that uses SAC as a plug-in for an ALC Server. Many aspects of the client application framework of FIG. 11 are similar to and fully described in detail in United States Patent Application Publication No. US 2009/0222842 published Sep. 3, 2009 (Narayanan et al., “System, Method and Apparatus for Controlling Multiple Applications and Services on a Digital Electronic Device”), which hereby is incorporated herein in its entirety by reference thereto. Other aspects are different, notably the ALC Server 262, and further enhance the software developer's experience.

The application environments shown in FIG. 11 are native application environments 204, such as the operating system environments Windows Mobile, Symbian and BREW, illustratively for applications such as native applications 206 written in languages such as C/C++; procedural runtime environments 214 such as Java environments for Java applications; and declarative runtime environments 224 such as widget runtime environments for widgets, and browser environments for webpage widgets. The SAC 290 is within the native OS environment 204.

The middleware in the FIG. 11 system is SAC 290, which provides a common set of functions and capabilities that are shared by the four ecosystems, and supports (a) modular and flexible application engine and technology and standards enabler modules; (b) multiple operating systems and platform environments without changes to the core software; and (c) interoperation with and abstraction from various network and service infrastructure systems. API's are provided in the platform interface 130 that are abstracted from each type of supported platform. The SAC 290 translates between the relevant API in the application interface 260 and the relevant API in the platform interface 130. For example, when an application programmer wishes to get a video stream from a platform codec, the programmer need only code the instruction in any supported programming language using the appropriate API in the application interface 260 for that language. Advantageously, the programmer need not have any particular knowledge of how the function is performed by the platform. This is because during operation, the SAC 290 through an application module 242 receives the request from the application, calls the appropriate platform driver for the platform being used, and passes the parameters between the API in the application interface 260 and an API in the platform interface that is appropriate for the platform in use. This process is known as “translation.” The appropriate platform driver in the platform interface 130 then accesses the platform using the appropriate calls and protocols for the platform to get the video stream. In a similar manner, the extension interface 120 and the service and network interface 140 contain “abstracted” API's, and the SAC 290 is able to translate between any of the interfaces 260, 120, 130 and 140. In the case of the extension interface 120, for example, when a new engine is “plugged into” engines 122, it publishes its procedures and parameters to the extension interface 120.

Command plug-ins 261 are provided for the ALC Server 262. The ALC Server 262 may be implemented in the same manner as the ALC Server 700 (FIG. 7), and the command plug-ins 261 may be implemented in the same manner as the command plug-ins 730 (FIG. 7). The ALC's 263, 265, 267 and 269 may also serve as plug-ins to the ALC Server 262. Functionality provided by command plug-ins 261 may but need not be omitted from the Application Engines 122 and Enablers 124 if applications 206, 216 and 226 request such functionality through the ALC Server 262. Applications preferably interact with the ALC Server 262 for all functions, although it may be desirable in some implementations for applications in the native application environment to interact directly with the ALC's 263, 265, 267 and 269.

Communication between the ALC Server 262 and the various applications and environments is over pipes. The pipes may be set up in a number of different ways. One illustrative way is to use an IP port/socket approach in which the ALC Server 262 may listen in on a socket or port for incoming requests from the applications in the various environments. Any application that runs in an environment that supports sockets or ports can use this approach. From an application developer perspective, this methods is similar to addressing a web based application through a port and the programming techniques are familiar to them. This reduces the learning needed to use this method in the various application environments. Each of the environments and applications have access to all standard functions available through, and functionality controlled by, the SAC 290, as well as the functions available from the command plug-ins 261.

The ALC Server 262 as shown in FIG. 11 may perform a number of functions. One function is to manage a document exchange process. An application can request some function. A J2ME game application, for example, may want to incorporate VoIP so that the game player can talk with another player of the same game during the gameplay, or may want to do video sharing within the game. However, J2ME, the mobile version of Java found in most feature phones, does not support VoIP or streaming, the latter being needed for video share. With the ALC Server 262 in place, the J2ME game application does not need to support VoIP or streaming, but instead uses the ALC Server 262 to request set up of the voice session and video share while playing the game. The ALC Server 262 in turn instructs elements to set up on behalf of the J2ME game application. The J2ME game application may request this functionality to be performed on its behalf, through, for example, an Application Control Document (“ACD”).

Another function that may be performed by the ALC Server 262 as shown in FIG. 11 is the sharing of data and state information among applications. Consider the situation wherein a Java application and a native application need access to the same data or state information. An example of state information that may be of interest is “Presence,” which is whether a person is online. Presence information may be updated by, for example, a native application, but the Java application may need the Presence information. To acquire the Presence information, the Java application, one of the applications running in a Java environment may access the Presence information by sending an ACD to the ALC Server 262 requesting the Presence information. The ALC Server 262 may reply with an ACD document containing the Presence information.

In a similar manner, data created by one application may be stored and share with other applications, even as between different application environments. Consider, for example, a Java application that is designed to store a user profile for use by a web application rendered in a browser. The Java application creates a Data Element (“DE”) and requests through the ALC Server 262 that it be stored in the SAC 290. Note that the application need not know that the SAC 290 exists or how the data is stored and managed, which greatly simplifies the profile sharing. The SAC 290 creates a data record in its database 251, and when the browser page launches, the browser based application requests the user profile from the SAC 251. The browser based application need only know that the user profile is being handled by the ALC Server 262, and has no need to know how the SLC Server 262 or the SAC 251 obtained the user profile. The requests and replies may be made with an ACD document exchanged with the ALC Server 262.

Another function performed by the ALC Server 262 as shown in FIG. 11 is to share state data and provide signaling for the functions. Consider, for example, the problem that many application environments and browsers on mobile phones do not perform power management well. Applications that must remain active even during periods of non-use can run the battery down on the device. For example, most J2ME Java environments do not support a sleep mode and critical communication applications must remain active to monitor events will cause the system to consume full power even when not is actual use. One approach to solving this issue is to set up a “wake-up on event” process managed by the SAC 290. When the event occurs, the SAC 290 sends a wake-up signal to the ALC Server 262 which determines which applications need the notification, performs the wake-up notification, and makes the current state data available to the application upon wakeup. The data and signaling may be done with an ACD document exchanged with the ALC Server 262.

As an example of signaling, consider that a Java application and a browser can signal one another when certain processes and tasks are done, through the ALC Server 510 using ACD documents and using SAC management.

Another example is policy and security management. Applying a consistent and reliable privacy and security model across multiple application environments has previously been difficult. This may be achieved using the ALC Server policy and security modules and/or using a SAC based security and policy management model that consistently applies the same model to all application environments. For example, access to sensitive data or functions may be managed through the ALC Server 290 and SAC policy and security management functions by requiring a key to be provided matching a specified security certificate. Thus, any application in any environment requesting the data or functions accessible through the ALC Server 290, such as a Java application or web based browser application, may be required to use the same method and supply the same credentials for access.

A. The Application Interface 260

FIG. 11 illustrates the general principle that a SAC may enable a variety of applications in multiple environments, or may serve as a plug-in to an ALC Server 262, or any combination thereof.

The following describes how the SAC 290 uses the application interface 260 to enable a variety of applications (e.g. 206, 216, 226) in multiple environments (e.g. 204, 214, 224), including procedural and declarative, and to establish application programming interfaces (“API's”) suitable for various categories of applications and application environments. An application programming interface or API is a set of routines, data structures, object classes and/or protocols provided by libraries and/or operating system services in order to support the building of applications. Application environments include native application environment 204, such as Windows Mobile, Symbian and BREW, for applications written in languages such as C/C++, and procedural runtime environments 214 such as Java. Declarative runtime environments 224 make use of web-like scripting and markup languages such as AJAX based widget environments like Yahoo Widgets and Webkit Run-Time, proprietary environments like Adobe's Flash Lite, and browsers enabled with AJAX or proprietary plug-ins like Microsoft Silverlight and Adobe Flash and Air.

The Application Interface 260 of the SAC 290 illustrates the general principle that a particular ALC may be used to connect any number (one or more) of the environments to the SAC 290. Native application environments like Symbian are by design capable of making calls to API's in an ALC when they need functionality that can be provided through the SAC 290. ALC's may be integrated to procedural runtime environments like Java by integration to the Java Virtual Machine through the Java VM native interface if present, or through bindings to the VM environment. ALC's may be integrated to declarative runtime environments through bindings in these environments. The ALC's 263, 265, 267 and 269 include application program interfaces (API's) and application logic, which enables the SAC 290 to support a set of application functions for the application environments and applications, such as a native application environment 204 and associated applications 206, a procedural runtime environment 214 and associated applications 216, and a declarative runtime environment 224 and associated applications 226.

Alternatively, or additionally, application logic controllers could be used for each of the specific application environments. An application interface may include Application Logic Controllers (“ALC's”) for various categories of functions and various application environments. The ALC's may vary to support the conventions and capabilities of the environment. For example, ALC's for native application environments may translate between the API's used in the SAC 290, the application engines 122, and the enablers 124, and perform application logic to further abstract the application from the complexities of the underlying technology or variations in implementations. ALC's that support procedural runtime environments 214 like Java may be either the same ALC's used for the native environment with bindings created to enable the application environment's virtual machine with the extended functions, or they may add application logic to perform functions for the runtime applications that are not supported or easily performed in the environment. Similarly, ALC's used to add extended functions to declarative runtime environments 224 may be the same ALC's used for the other environments with bindings added for the selected functions, or the ALC's may include most of the application logic needed to perform common functions for the category so that the declarative application need only perform the user interface functions and basic application logic. Using multiple derivative ALC's, the level and type of application interface can be varied for the different environments supported. In most cases, a common set of API's available to all environments is defined and supported by the ALC's, and then additional levels and functions may be included in others. For example, the policy module 252 and the state module 246 function in the SAC 290, and selected application functions may be required in all ALC's and environments, but access to specific engines and enablers may be limited to certain environments. Similarly the ALC's for native application environment 204 may provide a large set of low-level API's, while the ALC's for the declarative runtime environments 224 may include additional application logic so that a simplified set of higher-levels API's is provided for less capable environments.

B. The Platform Interface 130

In order to support porting to multiple operating systems and platform environments without changes to the core software, the SAC 290 provides platform independence for the functions of the SAC 290 and the elements that are integrated to the SAC 290. Specifically, the architecture of the SAC 290 includes the platform interface 130, which is a platform abstraction and porting layer that includes platform drivers (“PFD”). The platform interface 130 interfaces platform-specific operations, such as memory allocation and media playback, and abstract them from the applications. Platform drivers may handle OS services, which are features and functions typically provided by the operating system such as memory allocation and file system operations; and non-OS services, which are features and functions that typically are not provided by the operating system, such as compression and de-compression of media packets and setting quality of service parameters in a network transaction. Illustrative operating system and platform resources include UDP/TCP services, PDP services, HTTP services, media codecs, operating system services, and embedded applications such as messaging and location.

There are two types of platform driver API's, basic and advanced. Basic APIs are typically available in general purpose operating systems such as Windows, Windows Mobile, Symbian, and Linux. Some of the basic APIs include, but are not limited to memory allocation and management functions, string management functions, communication functions such as Socket, file Input and Output functions, thread management functions including Mutex and Semaphore, and timer management functions such as start/stop timers. Advanced API's usually involve integration with 3rd party software modules on the platform. Some of the advanced APIs include, but are not limited to media management such as Codec, Media Player functions, network management such as Quality of Service setup, optional application launcher functions in a multithreaded platform, inter Process Communication functions, functions to read or access SIM toolkit functions, functions to access OMA Device Management (DM) functions, and protected storage in memory or SIM card to save data securely. This is particularly useful when sensitive information such as Digital ID or Digital Wallet data are kept and managed in secured memory partitions or devices. Advantageously, once the PFD layer (e.g. PFD's 230, 232, 234, 236) is developed in the platform interface 130, it is relatively easy to adapt to different platforms and usually requires little additional work unless the basic platform functions change.

C. The Service and Network Interface 140

The architecture of the SAC 290 includes the service and network interface 140 and the communication module 240, which includes functions such as connection management, quality of service (QoS) management, and session management. The SAC 290 abstracts variations in service applications and service/network infrastructure (e.g. 142 and 144), device applications (e.g. 206, 216, 226) and application environments (e.g. 204, 214, 224), and device platforms (e.g. 132) from each other, in order to (a) minimize impact of changes or variations in one system from the others; (b) minimize testing effort and technical risk on a case-by-case basis when implementing across different device platforms and products; and (c) make applications developed for a given application environment more portable across various network systems and devices.

D. The Extension Interface 120

The extension interface 120 supports modular and flexible application engine and technology and standards enabler library integration. The SAC 100 (a) adapts API sets and conventions from various module suppliers and API conventions through a common integration and abstraction layer, the extension interface 120; (b) allows for exchange of engines and libraries independent of applications (application API's remain unchanged) for upgrades and special cases; and (c) supports state data sharing between engines through a common and controlled interface.

The SAC architecture allows third party technology providers to integrate application engines 122 and enablers 124 into the SAC 100 through the extension interface 120, so that features implemented by the application engines 122 and enablers 124 can be accessed through the SAC 100 via the application Interface 110. The extension interface 120 provides for a modular architecture, and flexible integration of the application engines 122 and the enablers 124. The extension interface 120 provides a layer of abstraction for the functions and features implemented in the application engines 122 and in the stateless enablers 124. This allows common applications and application logic controllers (ALC's) to be built that can work with multiple application engines 122 and enablers 124. The extension interface 120 allows the application engines 122 and the enablers 124 to share the state maintained in the SAC 100. This methodology provides a means to control access and manage policy centrally for all engines, enablers, and applications. This also enables the engines 122 and the enablers 124 to be changed or upgraded without changing the API's used to access them, and independent of the applications that use them.

Two categories of application engines may be envisioned: general purpose and application specific. The general purpose engines are typically used by many applications and application logic controllers, or when the system boots up. An example is a Session Initiation Protocol (“SIP”) User Agent (see, e.g., 431 in FIG. 5) that is used by many SIP applications such as Voice Over IP and Instant Messaging. An IMS Startup Engine (see, e.g., 435 in FIG. 5) is another example of a general purpose engine. The application-specific engines perform the logic and manage the state (illustratively for use in situation awareness such as Presence, Location, and Identity) and data management needed to perform the application function. For example, an Instant Messaging Engine may perform page mode and session mode operations for a specific IM protocol along with managing the necessary states needed to support them. Other examples include digital identity management, digital wallet management, rights management, situation management, contact and group list management, video share, VoIP and PoC. Managing user and application data, maintaining state transitions, providing data packing and management are typical functions of an engine.

Enablers 124 are generally “stateless,” that is they perform functions that do not require state information to be kept, and usually operate on a “request-response” model. Enablers 124 generally implement protocols defined by industry standards or specific technologies. Examples of industry standard enablers include modules that perform protocols such as SIP, HTTP, RTP, RTCP, SigComp, IMS Library functions, XDM, MSRP, presence, and device management. Examples of enablers based on proprietary specifications include functions and protocols like location, digital identity, digital rights, and security protocols.

The application engines 122 and the enablers 124 may have “dual” API access, in that they may be integrated to and accessed through SAC using API's in the application interface 110, and they may also be accessible directly from an application 206, 216, 226, or from other application engines 122 in cases where direct access is desired and the functions of the SAC 100 are not necessary.

In some cases, engine and enabler stacks may be layered to provide a common set of functions and API's that support multiple methods. The method to be used is determined by a rule set or provision-able policy. An example is the SIP stack described below with reference to FIG. 5. There are multiple SIP methods that may be required based on the network and/or service infrastructure requirements. These may vary depending on the application and service infrastructure element used.

E. Core Functions

The SAC 290 includes various core functions, illustratively a communication module 240, an application module 242, an extension management module 244, a state module 246, a server module 248, a data management module 250 which has an associated database 251, a policy module 252, a signaling module 254, and an administration module 256. These core functions are now described. An even more detailed description of these core functions is provided by United States Patent Application Publication No. US 2009/0222842 published Sep. 3, 2009 (Narayanan et al., “System, Method and Apparatus for Controlling Multiple Applications and Services on a Digital Electronic Device”), which hereby is incorporated herein in its entirety by reference thereto.

The communication module 240 is responsible for managing resources for channels used to communicate with services and service infrastructure 142 and networks 144. It uses the platform-specific functions implemented in various platform drivers (PFD's), illustratively PFD 230, PFD 232, PFD 234 and PFD 236 in the Platform Interface 130, to obtain the available local IP addresses and ports for channels. When the available local IP parameters (address or port) change, the communication module 240 will be notified by a platform driver. Subsequently, the communication module 240 recreates these channels for future communication needs. The communication module 240 also creates UDP or TCP connection with the network.

The application module 242 provides deployment and un-deployment of applications within the SAC 290 in cases where applications use the SAC ALC's such as ALC 263, ALC 265, ALC 267 and ALC 269. It also maintains state of the application, filter criteria used to route information or signal to and from applications, and a table including registered applications and application mappings. In addition, the application module 242 is also responsible for resolving conflicts among applications, and queuing and prioritizing requests from applications to various other modules within the SAC 290.

The extension module 244 is responsible for managing integration and support of application engines 122 and enablers 124. The extension module 244 loads an extension for an application when the application manager sends a request for it. Based on the configuration parameters of the extension, the extension module 244 may also load any other extensions that the current extension needs. Loading may be done from on-platform sources such as memory or storage devices, or from a server over the network. The extension module 244 also maintains a table that maps the applications and the extension(s) they are using. When an application invokes a function in the extension using the extension module 244, the extension module 244 validates the existence of such a function before invoking. The extension module 244 supports executing the functions in extensions using a single thread in a serial manner, or in parallel using multiple threads. The serial or parallel mode of execution depends on the support of threads in the platform.

The state module 246 is responsible for state management, including aggregating state, and sharing state information among and between applications 206, 216 and 226, application engines 122, services and service infrastructure 142, and device platform environments 132. The state module 246 interfaces with other managers and interfaces within the SAC 290 to share state information among applications, engines, device modules and services.

The data management module 250 in the SAC 290 is responsible for management of data within the SAC 290, as well as providing data sharing services from the interface components such as the applications 206, 216 and 226, and the application engines 122. The data base methodology of the data management module 250 may be varied based on the implementation requirements. For example, the data base can be in-memory on devices that do not have an external storage device, such as set-top-boxes and mobile phones. The data base can be a persistent data base on a storage device embedded or connected to the device, such as a flash memory card or disc drive. Various database management methods such as SQL, Access, Oracle, IBM database systems may be employed. The data management module 250 abstracts this mechanism through the various SAC interfaces 110, 120, 130 and 140, so that the applications and functions using the data management module 250 are not exposed to the underlying method. To store or share data, an application (e.g. 206, 216, 226) or an application engine (e.g. 122) defines a structure using a data structure document. The owning application may also set policy for access and control of the defined data through the policy module 252. The applications authorized to use the defined data may then access the database through the relevant SAC interface.

The policy module 252 handles the policy functions of the SAC 290, which are used to provide operational management parameters, access control, and administer security and privacy policies. Policies and parameters may be established by the user, network provider, service provider, device, or technology and standards provider. For example, a network operator and service provider may set policy for use of the network, access to service systems, or control access to sensitive state or application data. These policies are managed by various functions within the SAC 290, such as the network and session management functions, the state management function, data registration and application access in the application logic control layer. For example, based on user privacy policy or operator policy, an application may be required to submit a service provider issued key or certificate to access designated API's and data.

The policy module 252 is responsible for policy management. One or more policy profiles may be present on the digital electronic device, including policy profiles such as User Profiles, Service Provider Profiles, and Third Party Profiles approved by a service provider. The profiles contain access control information for accessing API's, state data, network services, network and service delivery Quality of Service, user data, and so forth. The policy profiles may optionally be certified using industry standard security mechanisms such as key exchange and certificates issued by well established authorities. User Profiles typically include policies for privacy and security for data and applications, such as “Share my presence or location information to a set of authorized applications.” Service Provider Profiles are service provider provisioned policies for access, privacy, and security for items managed or accessed via the SAC.

Policy provisioning for the policy module 252 may be performed at time of manufacture, at time of sale, on-line, or over the air by sending policy documents to the SAC 290, or by the user by setting policy parameters. For example, to set a policy on an OMA (Open Mobile Alliance) Device Management enabled mobile device, the service provider may use an existing OMA-DM enabled Device Management System to manage the policy documents and perform secure, authenticated delivery of a provider specified policy document, typically using an XML structure. The SAC 290 is registered with the on-device OMA-DM application to receive provisioning documents of that specific type sent over-the-air. An application engine is integrated with the SAC 290 that serves as the “handler” for the policy document type, and performs the parsing of the document and provisioning of the policy parameters managed in SAC.

The signaling module 254 is responsible for parsing signals from applications, engines, device and services, and for routing them to appropriate destinations. The destination could be an application (e.g. 206, 216, 226), engine (e.g. 122), device (e.g. 132), or service (e.g. 142). The signaling module 254 may use an enabler to parse the signal message, for example, if the signals are embedded in a standard protocol. Alternately, the signals can be simply a signaling message (for example, an XML data document) that contains information for the recipient. In this example, the signaling module 254 publishes the XML schema so applications, engines, device or services can use them to construct signals.

Applications 206, 216 and 226 and engines 122 may declare the signals to route and accept via the application interface 110 when performing the deployment process with the SAC 290. This is done using the application interface 110 and the deployment descriptor. The application module 242 routes the signals (typically commands) to the signaling module 254. For example, a camera application can publish its signals (start capture, stop capture, etc) to the SAC 290. A messaging application can query the signaling module 254, obtain the signals supported by the Camera application, and issue a signal to the signaling module 254 that reaches the Camera application.

An engine (e.g. 122) may declare signals requested to be routed to it via the extension interface 120 when performing the deployment process with the SAC 290. This is done using the extension interface 120 and the deployment descriptor. The extension module 244 routes the signals to the signaling module 254. For example, a payment engine (not shown) may publish its signals (get balance, pay balance, etc) to the SAC 290. A payment application (not shown) may query the signaling module 254, obtain signals supported by the payment engine, and issue a signal to the signaling module 254 that would reach the payment engine.

Using the service and network interface 140, an application (e.g. 206, 216, 226) or engine (e.g. 122) may declare signals requested to route to it from the network or network based services via the SAC 290 when performing the deployment process. This is done either using the application interface 110 or the extension interface 120, and the deployment descriptor. When the signaling module 254 receives a message from the network (e.g. 144), it filters the message based on the filter criteria and sends the message to the (e.g. 206, 216, 226) or engine (e.g. 122). For example, in an IMS enabled network, there is a network element called P-CSCF which routes incoming SIP messages to application access technologies based on a filter criteria stored in the network. The signaling module 254 performs a similar function in the device when it is enabled for IMS based communications.

The administration module 256 is responsible for keeping track of the internal functions of the SAC 290. The administration module 256 accesses data and information stored using the data management module 250, and makes it available to an administration application (not shown). The administration application is a privileged application that can access the administration module 256 using special API's. These API's are used to determine the number of applications deployed, active, type of communication channels open, active, and other data stored in the database 251 or provided by the various core functions in the SAC 290 and the extensions.

The server module 248 is responsible for invoking other modules in the SAC 290 based on requests from any of the modules or the interfaces. When applications or engines are deployed with the SAC 290, the server module starts a timer and maintains a heart-beat communication with them. This allows the SAC 290 to maintain status and determine whether the application or engine is active and responsive. When the application or engine terminates during the normal un-deployment process, the server module 248 stops the timer and the heart-beat mechanism. If the application terminates without a normal un-deploy, then the application state is set as an unexpected or abnormal termination.

Other Implementation Considerations

While the systems and methods described herein are useful for many different types of digital electronic devices, including personal computers, workstations, and home and office appliances, they are particularly useful for personal digital electronic devices, and particularly those that are wireless-communications enabled and mobile. “Personal digital electronic devices” are digital electronic devices that can be personalized for the user. They may be easily carried on the person, and include such devices as mobile phones, personal digital assistants (“PDA”), gaming devices, audio and video players, fobs, and USB Flash drives. They may be intended for use at a fixed location in a home, office or vehicle, and include such devices as external hard drives and on-demand cable boxes. Personal digital electronic devices are suitable for many uses, including communications, entertainment, security, commerce, guidance, data storage and transfer, and so forth, and may be dedicated to a particular use or may be suitable for a combination of uses. Personal digital electronic devices have various capabilities that may be used to present digital transaction documents and secured digital transaction documents at transaction facilities, including speakers, screens, wired personal area networks such as USB and FireWire, wireless personal area networks such as IrDA, Bluetooth, UWB, Z-Wave and ZigBee, and the MoBeam technology.

The systems and methods described herein may be realized in software, or in hardware such as an ASIC or chip set, or in a combination of software and hardware. When implementation is done using hardware, it includes a processor and memory. The core functions of the SAC and the ALC Server may be implemented in the ASIC, and the memory is used to store state, data and other information required for functioning of the SAC. The functions, interfaces and intercommunication among various modules described in the embodiments remains the same for the hardware based implementation as well. The algorithms, logic and processing done in ALC and PFD modules are implemented in the ASIC, and expose the interfaces to external components. The extension module within the ASIC loads the executable(s) for the extensions into memory and executes them whenever needed.

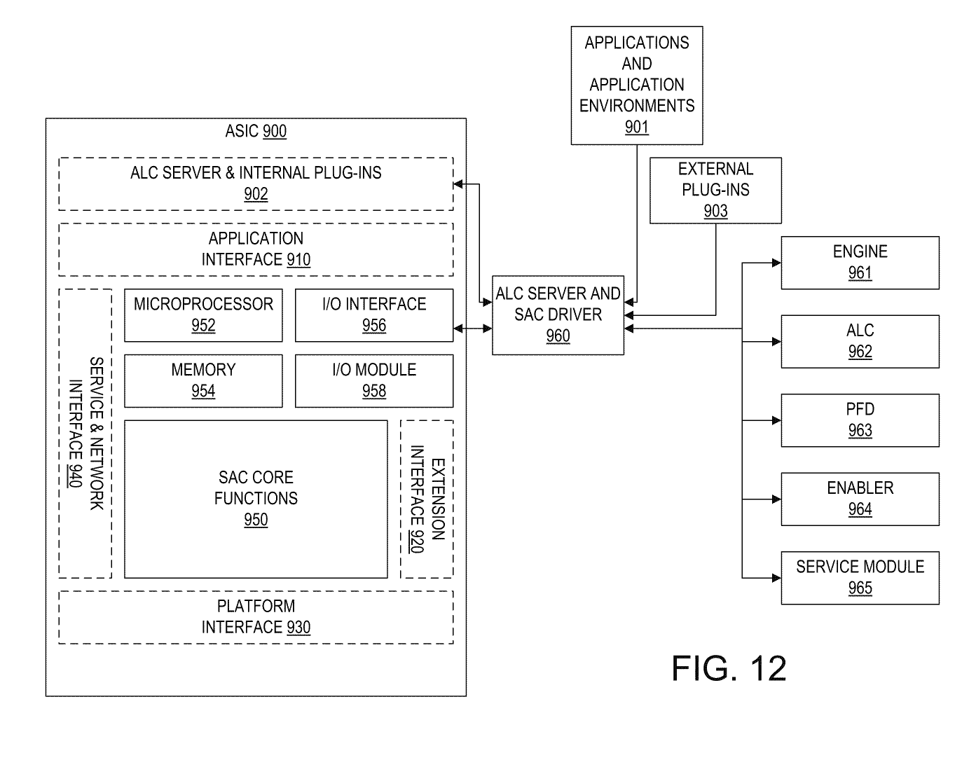

FIG. 12 shows an illustrative ASIC implementation 900. The ALC Server and Internal Plug-ins 902 (internal plug-ins are optional), SAC core functions 950, application interface 910, extension interface 920, platform interface 930, service and network interface 940, microprocessor 952, memory 954, I/O interface 956, and I/O module 958 are implement on the ASIC chip. External plug-ins 903 may be provided if desired, and interact with the ALC Server and Internal Plug-ins 902 via the ALC Server and SAC Driver 960. The Applications and Application Environments 901 interact with the ASIC 900 via the ALC Server and SAC Driver 960. The various components external of the ASIC 900 may be based on software to facilitate changes and adaptation to specific platforms and application requirements. Specifically, external plug-ins 903, engine 961, ALC's 962, PFD's 963, enablers 964, and service interface modules 965 are software modules that interrelate with the ASIC 900 over an interface using a driver. For example, as depicted in FIG. 12 in one illustrative implementation, the software elements interrelate to the ASIC 900 through ALC Server and SAC Driver 960, which controls a high-speed serial Input/Output channel with appropriate signaling channels. I/O module 958 manages the Inter-Process Communication to the appropriate interface and to the SAC core functions 950. The ALC Server and SAC Driver 960 provides API's to the ALC's 962, PFD's 963, engines 961, enablers 964, and service modules 965 based on the interface type. The ALC Server and SAC Driver 960 supports the API's and performs the translation and coding needed to convert them to the serial data format and protocol used by the ASIC 900. Likewise, the ALC Server and SAC Driver 960 converts the information from the ASIC 900 into an appropriate interface format, and performs the API support needed by the ALC's 962, PFD's 963, engines 961, enablers 964, and service modules 965. In this illustrative implementation, the components that interact with the ASIC 900 use the same API's and methodology when interrelating with the ALC Server and SAC Driver 960 as they do when interacting directly with a software implementation of the ALC Server and SAC. The service module 965 is used by the service and network interface as an adapter to interoperate with various network, service infrastructure, and service application systems.

The I/O Interface 956 and the driver methodology can be varied to support other requirements. For example, in more demanding and complex implementations, the I/O interface 956 can be implemented as multiplexed channels or a Bus interface. Separate drivers can be implemented for each interface type.

The techniques described herein may be combined in various ways. In one illustrative implementation, the SAC is integrated to a device platform through the device interface, and a network-based service is included through the service and network Interface. The ALC Server implementation of the ASIC is used to provide an on-device service that allows service applications to discover and access or deliver data, signaling, messaging, or situation information to or from unknown device functions. Similarly, device platform functions may discover and access information provided by unknown service functions. In this case, the service application and the device function are not required to use a common method or even be aware of the origin of the information. For example, a location based service function in the device may register and store location data via an ALC Server plug-in. The service application can make an inquiry via the ALC Server for location data and retrieve the data descriptor and the location data. The service application may set a service policy for use of the network and the various device platform retrieve the policy information and perform the operations determined by the policy.

In another illustrative embodiment, a device is used for monitoring and communication with a service through a connection such as a security or telemetry device. An ALC Server is implemented in the device with the service and network interface used to support the network connection and service, the platform interface is used to integrate with the device, and the extension interface is used to integrate with an enabler and engine that is used to implement a proprietary and secure transport protocol and monitor data from a specialized device. In this case, no application integration is required since the application is performed on the service. This method allows the service engine and enabler configuration to be used in multiple devices from multiple sources without the device being aware of the particular methods and security used, while still using the device platform resources. Alternatively, this method can be used to support multiple services with proprietary protocols and methods from a single device platform.

Further technical information that may be useful as background or for implementing various aspects of the architecture and methods described herein are described in the following documents, which are available from Ecrio Inc. of Cupertino, Calif., and are incorporated herein in their entirety by reference thereto: (A) Ecrio Inc., Advanced Communications and Commerce Solutions for Mobile Phones: Internet Protocol Multimedia Subsystem (IMS) Software Development Kit (SDK), 2007 (downloaded off the Internet from site http://www.ecrio.com/products/ims_library.html on Feb. 1, 2008); (B) Ecrio Inc., Ecrio SAC Product Specification Document, September 2009; (C) Ecrio Inc., Ecrio SAC Architecture and Design Document, September 2009; (D) Ecrio Inc., Ecrio SAC Application Programming Interface Specification Document, September 2009; and (E) Ecrio Inc., Ecrio Simple Command Protocol Design, 2010.

The various embodiments of the invention described herein are illustrative of our invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention, as set forth in the following claims.

1. A method for providing functions to a plurality of applications running in a plurality of application environments on a digital electronic device, comprising:
enabling an application function server with at least one function from at least one plug-in through at least one API, the application function server and the plug-in being on the digital electronic device;
communicating information pertaining to a function request for the function issued by any one of the applications, between the application issuing the function request and the plug-in and through the application function server, the applications being compliant with an application command protocol comprising commands, notifications, acknowledgements, data relating to the function request, or any combination thereof; and
processing, within the application function server, the information pertaining to the function request to interact with the plug-in and perform the function on behalf of the application issuing the function request.

2. The method of claim 1 wherein the plug-in is a command plug-in internal to the application function server.

3. The method of claim 1 wherein the plug-in is a command plug-in external to the application function server.

4. The method of claim 1 wherein the plug-in is middleware.

5. The method of claim 4 wherein the middleware comprises a services and communication controller.

6. The method of claim 1 further comprising:
enabling the application function server with additional functions from a plurality of additional plug-ins through respective additional API's, the additional plug-ins being on the digital electronic device;
wherein one of the plug-in and additional plug-ins is middleware, another one is an internal command plug-in, and another one is an external command plug-in.

7. The method of claim 1 wherein:
the information pertaining to the function request comprises a command from the application issuing the function request; and
wherein the processing step comprises:
confirming that server policy allows the command to be handled;
confirming that capability is available for handling the command; and
parsing the command on behalf of the plug-in for the requested function.

8. The method of claim 1 wherein the communicating step comprises communicating the information pertaining to the function request between the application issuing the function request and the application function server by use of socket-based communications.

9. The method of claim 1 wherein the communicating step comprises communicating the information pertaining to the function request between the application issuing the function request and the application function server by use of command lines.

10. The method of claim 1 wherein the communicating step comprises communicating the information pertaining to the function request between the application issuing the function request and the application function server by use of application control documents.

11. The method of claim 1 wherein the plug-in is a command plug-in, further comprising providing the command plug-in with a platform specific plug-in shell for wrapping the command plug-in in a platform specific mechanism, a command plug-in interface comprising a set of functions that are directly callable by name when the command plug-in is loaded on the application function server, and a command implementation comprising an Initialize Command Plug-in API, a De-Initialize Command Plug-in API, a Get Information of Command Plug-in API, a Get List of Commands API, an Arm Command Plug-in API, a Disarm Command Plug-in API, and an Execute Command API.

12. The method of claim 1 further comprising:
enabling the application function server with additional functions from a plurality of additional plug-ins through respective additional API's, the additional plug-ins being on the digital electronic device;
wherein the processing step further comprises applying a defined policy to control access to and use of the functions in the plug-in and in the additional plug-ins.

13. The method of claim 12 wherein:
the defined policy is set forth in a policy configuration file;
the processing step comprises securely managing the policy configuration file and the information pertaining to the function request during the processing step on a secure database maintained on the digital electronic device; and
the communicating step comprises securely communicating the information pertaining to the function request between the application issuing the function request and the application function server, and between the application function server and the plug-in.

14. The method of claim 1 further comprising:
collecting, within the application function server, application use data; and
maintaining, within the application function server, a database comprising the application use data collected in the collecting step.

15. The method of claim 14 further comprising evaluating the application use data with one of the applications.

16. The method of claim 14 wherein the function is a network access function, further comprising:
securing access to an external network using the network access function of the plug-in; and
sharing the operationally generated application-related analytics and plug-in related analytics via the external network.

17. The method of claim 1 further comprising enabling the application function server with additional functions from a plurality of additional plug-ins through respective additional API's, the additional plug-ins being on the digital electronic device, wherein the plug-in and additional plug-ins enable the application function server with a contacts function, a file share function, a video share function, a presence function, a messaging function, a voice calling function, a location function, or any combination thereof.

18. The method of claim 1 wherein the application environments comprise a native application environment, a procedural runtime environment, and a declarative runtime environment.

19. The method of claim 1 wherein one of the applications is a commerce application, further comprising enabling an application function server with at least one commerce-related function from the plug-in.

20. The method of claim 1 wherein one of the applications is a communications application, further comprising enabling an application function server with at least one communications-related function from the plug-in.

21. An application function server for providing functions to a plurality of applications running in a plurality of application environments on a digital electronic device, comprising:
an application manager for tracking registration of the applications and for routing notifications to the applications;
a socket server for listening for incoming connections, receiving command messages from the applications, and sending notifications to the applications;
a command parser processor for parsing commands from the applications;
a command dispatcher for validating commands from the applications;
a plug-in manager for loading, tracking and unloading plug-ins;
a command manager for processing commands validated by the command dispatcher in accordance with a rules-based policy, and requesting the plug in manager to execute the processed commands;
a policy manager for applying rules and conditions during operations;
a database manager for managing data during operations;
a security manager for securing data communications and storage during operations; and
a core manager module for sequencing initialization and configuration of the application manager, the socket server, the command parser processor the command dispatcher, the command manager, the plug-in manager, the policy manager, the database manager, and the security manager.

22. A computer readable storage medium containing computer executable instructions that, when executed by a digital electronic device, cause the digital electronic device to perform a method for providing functions to a plurality of applications running in a plurality of application environments on the digital electronic device, the method comprising:
enabling an application function server with at least one function from at least one plug-in through at least one API, the application function server and the plug-in being on the digital electronic device;
communicating information pertaining to a function request for the function issued by any one of the applications, between the application issuing the function request and the plug-in and through the application function server, the applications being compliant with an application command protocol comprising commands, notifications, acknowledgements, data relating to the function request, or any combination thereof; and
processing, within the application function server, the information pertaining to the function request to interact with the plug-in and perform the function on behalf of the application issuing the function request.

23. The computer readable storage medium of claim 22 wherein the method further comprises:
collecting, within the application function server, application use data; and
maintaining, within the application function server, a database comprising the application use data collected in the collecting step; and
enabling the application function server with additional functions from a plurality of additional plug-ins through respective additional API's, the additional plug-ins being on the digital electronic device;
wherein one of the applications is a commerce application and one of the plug-in and additional plug-ins provides a commerce-related function;
wherein one of the applications is a communications application and one of the plug-in and additional plug-ins provides a communications-related function;
wherein one of the plug-in and additional plug-ins is middleware, another one is an internal command plug-in, and another one is an external command plug-in;
wherein the processing step further comprises applying a defined policy set forth in a policy configuration file to control access to and use of the functions in the plug-in and in the additional plug-ins.
wherein the processing step further comprises securely managing the policy configuration file and the information pertaining to the function request during the processing step on a secure database maintained on the digital electronic device; and
the communicating step comprises securely communicating the information pertaining to the function request between the application issuing the function request and the application function server, and between the application function server and the plug-in.

24. A digital electronic device comprising a processor and memory, the processor being operatively configured by instructions in the memory to run a plurality of applications in a plurality of application environments, and to provide functions to the applications in accordance with a method comprising:
enabling an application function server with at least one function from at least one plug-in through at least one API, the application function server and the plug-in being on the digital electronic device;
communicating information pertaining to a function request for the function issued by any one of the applications, between the application issuing the function request and the plug-in and through the application function server, the applications being compliant with an application command protocol comprising commands, notifications, acknowledgements, data relating to the function request, or any combination thereof; and
processing, within the application function server, the information pertaining to the function request to interact with the plug-in and perform the function on behalf of the application issuing the function request.

25. The digital electronic device of claim 24 wherein the method further comprises:
collecting, within the application function server, application use data; and
maintaining, within the application function server, a database comprising the application use data collected in the collecting step; and
enabling the application function server with additional functions from a plurality of additional plug-ins through respective additional API's, the additional plug-ins being on the digital electronic device;
wherein one of the applications is a commerce application and one of the plug-in and additional plug-ins provides a commerce-related function;
wherein one of the applications is a communications application and one of the plug-in and additional plug-ins provides a communications-related function;
wherein one of the plug-in and additional plug-ins is middleware, another one is an internal command plug-in, and another one is an external command plug-in;
wherein the processing step further comprises applying a defined policy set forth in a policy configuration file to control access to and use of the functions in the plug-in and in the additional plug-ins.
wherein the processing step further comprises securely managing the policy configuration file and the information pertaining to the function request during the processing step on a secure database maintained on the digital electronic device; and
the communicating step comprises securely communicating the information pertaining to the function request between the application issuing the function request and the application function server, and between the application function server and the plug-in.
